(19) United States
(12) Patent Application Publication
(10) Pub. No.: US 2021/0218493 A1
(43) Pub. Date: Jul. 15, 2021

(54) MODULATION AND CODING AND CQI REPORTING METHOD, DEVICE, APPARATUS, AND STORAGE MEDIUM

(71) Applicant: ZTE CORPORATION, Shenzhen (CN)

(72) Inventors: Mengzhu CHEN, Shenzhen (CN); Liguang LI, Shenzhen (CN); Luanjian BIAN, Shenzhen (CN); Jun XU, Shenzhen (CN); Jin XU, Shenzhen (CN)

(21) Appl. No.: 17/054,755

(22) PCT Filed: May 13, 2019
(86) PCT No.: PCT/CN2019/086672

§ 371 Date: Nov. 11, 2020

(30) Foreign Application Priority Data
May 11, 2018 (CN) 201810451037.4

(51) Int. Cl. H04L 1/00; H04W 8/24; H04W 72/04; H04L 27/26

(52) U.S. Cl. CPC H04L 1/0004; H04L 1/0061; H04L 27/26025; H04W 72/042; H04W 72/0466; H04W 8/24

(57) ABSTRACT

Provided are modulation and coding method and apparatus, channel quality indicator (CQI) reporting method and apparatus, a device and a storage medium. In an MCS table set, an MCS table supporting a minimum spectral efficiency less than 120/1024*2 is added, and a selecting rule of an MCS table is provided. Therefore, compared with an MCS table set in the related protocols, communications requirements of higher reliability, higher coverage and lower transmission rate can be satisfied. Moreover, further provided are CQI reporting method and apparatus, a device and a storage medium to accurately satisfy current communications requirements, especially the communications requirements of higher reliability, higher coverage and lower transmission rate.

### TECHNICAL FIELD

The present disclosure relates to the field of communications and, in particular, to a modulation and coding method and apparatus and a channel quality indicator (CQI) reporting method and apparatus, a device and a storage medium.

### BACKGROUND

In a mobile communications system, due to the time-varying characteristic of a wireless fading channel, a technology for dealing with the time-varying characteristic of the channel to obtain an optimal communications effect by adaptively adjusting the transmit power, the modulation and coding scheme and the frame length of data according to a channel state is referred to as an adaptive coding and modulation technology, and belongs to the most typical link adaptation technology.

For a physical uplink shared channel (PUSCH) and a physical downlink shared channel (PDSCH), a base station transmits a modulation and coding scheme (MCS) index or an MCS field and resource allocation information through downlink control information (DCI). The base station scrambles a cyclic redundancy check (CRC) bit corresponding to the downlink control information by adopting a specific radio network temporary identity (RNTI), and transmits the downlink control information in a particular DCI format through a physical downlink control channel (PDCCH). A terminal performs blind detection in common search space (CSS) and UE-specific search space (USS) to acquire the downlink control information.

For an MCS table of Table 1, MCS levels or MCS fields are represented by integer values of 0 to 31 respectively representing different MCS levels, QAM represents quadrature amplitude modulation, and QPSK represents quadrature phase shift keying, which is a digital modulation scheme. In the Table 1, spectral efficiency=code rate×modulation order, and modulation orders of BPSK, QPSK, 16QAM and 64QAM are respectively 1, 2, 4 and 6. When 29≤IMCS≤31, the modulation orders are ones in a case where a code block is retransmitted.

TABLE 1

| MCS | Modulation | Target code Rate | Spectral |
|---|---|---|---|
| Index I_{MCS} | Order Qₘ | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

In current protocols, three MCS tables are supported, namely an MCS_6 table supporting a maximum modulation order of 6, a minimum modulation order of 2, a maximum spectral efficiency of 948/1024*6 and a minimum spectral efficiency of 120/1024*2, an MCS_8 table supporting a maximum modulation order of 8, the minimum modulation order of 2, a maximum spectral efficiency of 948/1024*8 and the minimum spectral efficiency of 120/1024*2 and an MCS_6 BPSK table supporting the maximum modulation order of 6, a minimum modulation order of 1 or 2, the maximum spectral efficiency of 948/1024*6 and the minimum spectral efficiency of 120/1024*2. The MCS_6 BPSK table supporting the minimum modulation order of 1 or 2 refers to that in a case where a user equipment (UE) reports that pi/2 BPSK modulation is not supported, the minimum modulation order of the MCS_6 BPSK table is 2, and otherwise the minimum modulation order of the MCS_6 BPSK table is 1. The base station indicates the currently used MCS table through configuration signaling. As communications technologies evolve, the terminal requires higher reliability, higher coverage, and a lower transmission rate, such as in one of the scenarios of the fifth generation mobile communications: ultra-reliable and low latency communications (URLLC). However, in the current modulation schemes of three MCS tables in new radio (NR), the minimum spectral efficiency supported is 120/1024*2=0.2344, which does not satisfy the communications requirements of higher reliability, higher coverage and lower transmission rate.

### SUMMARY

Modulation and coding method and apparatus and CQI reporting method and apparatus, a device and a storage medium provided by embodiments of the present disclosure mainly solve a technical problem that MCS tables and CQI tables in the related protocols cannot satisfy communications requirements of higher reliability, higher coverage and lower transmission rate.

To solve the above-mentioned technical problem, an embodiment of the present disclosure provides a modulation and coding method including steps described below.

An MCS table is selected from an MCS table set according to a predefined rule.

A modulation order and a target code rate are determined according to the selected MCS table and a modulation and coding scheme field in downlink control signaling.

The MCS table set includes an MCS table supporting a minimum spectral efficiency less than 120/1024*2.

In an embodiment of the present disclosure, the MCS table set at least includes following three MCS tables: an MCS_6 table supporting a maximum modulation order of 6, a minimum modulation order of 2, a maximum spectral efficiency of 948/1024*6 and a minimum spectral efficiency of 120/1024*2; an MCS_8 table supporting a maximum modulation order of 8, a minimum modulation order of 2, a maximum spectral efficiency of 948/1024*8 and a minimum spectral efficiency of 120/1024*2; and an MCS_U table supporting a maximum modulation order of 6, a minimum modulation order of 2, a maximum spectral efficiency not greater than 772/1024*6 and a minimum spectral efficiency greater than or equal to 30/1024*2 and less than or equal to 50/1024*2.

In an embodiment of the present disclosure, the MCS table set at least includes following three MCS tables: an MCS_6_BPSK table supporting a maximum modulation order of 6, a minimum modulation order of 1 or 2, a maximum spectral efficiency of 948/1024*6 and a minimum spectral efficiency of 120/1024*2; the MCS_8 table supporting the maximum modulation order of 8, the minimum modulation order of 2, the maximum spectral efficiency of 948/1024*6 and the minimum spectral efficiency of 120/1024*2; and an MCS_U_BPSK table supporting a maximum modulation order of 6, a minimum modulation order of 1 or 2, a maximum spectral efficiency not greater than 772/1024*6 and a minimum spectral efficiency greater than or equal to 30/1024*2 and less than or equal to 50/1024*2.

In an embodiment of the present disclosure, the predefined rule at least relates to one of: a link direction; higher-layer configuration signaling; a user category or a user capability; a downlink control signaling format, where the downlink control signaling carries the modulation and coding scheme field; a cyclic redundancy check (CRC) scrambling method corresponding to the downlink control signaling, where the downlink control signaling carries the modulation and coding scheme field; a channel quality indicator table corresponding to a reported channel quality indicator; a predefined subcarrier spacing set; a predefined time domain resource mapping method; a predefined frequency domain resource set; a predefined antenna port set; or a predefined set of numbers of transmission layers.

In an embodiment of the present disclosure, the predefined rule at least relates to: the link direction; the higher-layer configuration signaling; the downlink control signaling format, where the downlink control signaling carries the modulation and coding scheme field; and the CRC scrambling method corresponding to the downlink control signaling, where the downlink control signaling carries the modulation and coding scheme field.

In an embodiment of the present disclosure, the higher-layer configuration signaling includes first indication signaling and first MCS table indication signaling.

In a case where transmission data satisfies a first condition, selecting an MCS table to determine a modulation and coding scheme at least includes one of cases described below.

In a case where the first indication signaling is in a state 1-1, in response to the first MCS table indication signaling being set to 256QAM, the MCS_8 table is selected to determine the modulation and coding scheme, and in response to the first MCS table indication signaling being not set to 256QAM, an MCS_6_x table is selected to determine the modulation and coding scheme.

In a case where the first indication signaling is in a state 1-1, an MCS_6_x table is selected to determine the modulation and coding scheme.

In a case where the first indication signaling is in a state 1-2, in response to the first MCS table indication signaling being set to 256QAM, the MCS_8 table is selected to determine the modulation and coding scheme, and in response to the first MCS table indication signaling being not set to 256QAM, an MCS_U_x table is selected to determine the modulation and coding scheme.

In a case where the first indication signaling is in a state 1-2, an MCS_U_x table is selected to determine the modulation and coding scheme.

In a case where the first indication signaling is in a state 1-3, in response to the first MCS table indication signaling being set to 256QAM, the MCS_8 table is selected to determine the modulation and coding scheme, and in response to the first MCS table indication signaling being not set to 256QAM, an MCS_6_x table is selected to determine the modulation and coding scheme.

In a case where the first indication signaling is in a state 1-3, an MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the higher-layer configuration signaling includes first indication signaling; and in a case where transmission data satisfies a second condition, selecting an MCS table to determine a modulation and coding scheme at least includes one of cases described below.

An MCS_6_x table is selected to determine the modulation and coding scheme.

In a case where the first indication signaling is in a state 1-2, an MCS_U_x table is selected to determine the modulation and coding scheme.

In a case where the first indication signaling is not set to be in the state 1-2, an MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the first indication signaling is block error rate-target (BLER-target) indication signaling, the state 1-1 is 10⁻¹, the state 1-2 is 10⁻⁵, and the state 1-3 is an absent state or a default state.

In an embodiment of the present disclosure, the higher-layer configuration signaling includes second indication signaling and second MCS table indication signaling.

In a case where transmission data satisfies a first condition, selecting an MCS table to determine a modulation and coding scheme at least includes one of cases described below.

In a case where the second indication signaling is in a state 2-1, in response to the second MCS table indication signaling being set to 256QAM, the MCS_8 table is selected to determine the modulation and coding scheme, and in response to the second MCS table indication signaling being not set to 256QAM, an MCS_6_x table is selected to determine the modulation and coding scheme.

In a case where the second indication signaling is in a state 2-1, an MCS_6_x table is selected to determine the modulation and coding scheme.

In a case where the second indication signaling is in a state 2-2, in response to the second MCS table indication signaling being set to 256QAM, the MCS_8 table is selected to determine the modulation and coding scheme, and in response to the second MCS table indication signaling being not set to 256QAM, an MCS_U_x table is selected to determine the modulation and coding scheme.

In a case where the second indication signaling is in a state 2-2, an MCS_U_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the higher-layer configuration signaling includes second indication signaling; and in a case where transmission data satisfies a second condition, selecting an MCS table to determine a modulation and coding scheme at least includes one of cases described below.

An MCS_6_x table is selected to determine the modulation and coding scheme.

In a case where the second indication signaling is in a state 2-1, an MCS_6_x table is selected to determine the modulation and coding scheme.

In a case where the second indication signaling is in a state 2-2, an MCS_U_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the second indication signaling is BLER-target indication signaling, the state 2-1 is 10⁻¹, an absent state or a default state and the state 2-2 is 10⁻⁵, or the state 2-1 is 10⁻¹ and the state 2-2 is 10⁻⁵, an absent state or a default state.

Alternatively the second indication signaling is ultra-reliable and low latency communications (URLLC) indication signaling indicating whether URLLC is supported, the state 2-1 is that the URLLC is not supported, and the state 2-2 is that the URLLC is supported.

Alternatively, the second indication signaling is indication signaling indicating whether MCS_U_x is supported, the state 2-2 is that MCS_U_x of URLLC is supported and the state 2-1 is a state other than the state 2-2, or the state 2-2 is that MCS_U_x is supported, an absent state or a default state and the state 2-1 is a state other than the state 2-2.

In an embodiment of the present disclosure, the higher-layer configuration signaling includes third MCS table indication signaling; and in a case where transmission data satisfies a first condition, selecting an MCS table to determine a modulation and coding scheme at least includes one of cases described below.

In a case where the third MCS table indication signaling is in a state mcs-3-1, an MCS_6_x table is selected to determine the modulation and coding scheme.

In a case where the third MCS table indication signaling is in a state mcs-3-2, the MCS_8 table is selected to determine the modulation and coding scheme.

In a case where the third MCS table indication signaling is in a state mcs-3-3, an MCS_U_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the higher-layer configuration signaling includes third MCS table indication signaling; and in a case where transmission data satisfies a second condition, selecting an MCS table to determine a modulation and coding scheme at least includes one of cases described below.

An MCS_6_x table is selected to determine the modulation and coding scheme.

In a case where the third MCS table indication signaling is in a state mcs-3-3, an MCS_U_x table is selected to determine the modulation and coding scheme.

In a case where the third MCS table indication signaling is not set to be in the state mcs-3-3, an MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the state mcs-3-1 of the third MCS table indication signaling indicates the MCS_6_x table, the state mcs-3-2 of the third MCS table indication signaling indicates the MCS_8 table, and the state mcs-3-3 of the third MCS table indication signaling indicates the MCS_U_x, an absent state or a default state.

In an embodiment of the present disclosure, the higher-layer configuration signaling includes fourth indication signaling and/or fourth MCS table indication signaling; and in a case where transmission data satisfies a first condition, selecting an MCS table to determine a modulation and coding scheme at least includes one of cases described below.

In a case where the fourth indication signaling is in a state 4-1, an MCS_6_x table is selected to determine the modulation and coding scheme.

In a case where the fourth indication signaling is in a state 4-2, an MCS_U_x table is selected to determine the modulation and coding scheme.

In response to the fourth MCS table indication signaling being set to 256QAM, the MCS_8 table is selected to determine the modulation and coding scheme.

In response to the fourth MCS table indication signaling being not set to 256QAM, an MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the higher-layer configuration signaling includes fourth indication signaling and/or fourth MCS table indication signaling; and in a case where transmission data satisfies a second condition, selecting an MCS table to determine a modulation and coding scheme at least includes one of cases described below.

An MCS_6_x table is selected to determine the modulation and coding scheme.

In a case where the fourth indication signaling is in a state 4-2, an MCS_U_x table is selected to determine the modulation and coding scheme.

In a case where the fourth indication signaling is not in the state 4-2, an MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, in response to the fourth indication signaling and the fourth MCS table indication signaling being simultaneously acquired, the modulation and coding scheme is determined by one, which has a higher priority, of the fourth indication signaling and the fourth MCS table indication signaling.

In an embodiment of the present disclosure, the fourth indication signaling is BLER-target indication signaling, the state 4-1 is 10⁻¹, an absent state or a default state and the state 4-2 is 10⁻⁵, or the state 4-1 is 10⁻¹ and the state 4-2 is 10⁻⁵, an absent state or a default state.

Alternatively, the fourth indication signaling is URLLC indication signaling indicating whether URLLC is supported, the state 4-1 is that the URLLC is not supported, and the state 4-2 is that the URLLC is supported.

Alternatively, the fourth indication signaling is indication signaling indicating whether MCS_U_x is supported, the state 4-2 is that MCS_U_x of URLLC is supported and the state 4-1 is a state other than the state 4-2, or the state 4-2 is that MCS_U_x is supported, an absent state or a default state and the state 4-1 is a state other than the state 4-2.

In an embodiment of the present disclosure, the higher-layer configuration signaling includes fifth indication signaling and fifth MCS-1 table indication signaling; and in a case where transmission data satisfies a first condition, selecting an MCS table to determine a modulation and coding scheme at least includes one of cases described below.

In a case where the fifth indication signaling is in a state 5-1, in response to the fifth MCS-1 table indication signaling being set to 256QAM, the MCS_8 table is selected to determine the modulation and coding scheme.

In a case where the fifth indication signaling is in the state 5-1, in response to the fifth MCS-1 table indication signaling being not set to 256QAM, an MCS_6_x table is selected to determine the modulation and coding scheme.

In a case where the fifth indication signaling is in a state 5-2, in response to fifth MCS-2 indication signaling being set to be in a state mcs-5-1, an MCS_6_x table is selected to determine the modulation and coding scheme.

In a case where the fifth indication signaling is in the state 5-2, in response to fifth MCS-2 indication signaling being set to be in a state mcs-5-2, an MCS_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the higher-layer configuration signaling includes fifth indication signaling and fifth MCS-1 table indication signaling; and in a case where transmission data satisfies a second condition, selecting an MCS table to determine a modulation and coding scheme at least includes one of cases described below.

An MCS_6_x table is selected to determine the modulation and coding scheme.

In a case where the fifth indication signaling is in a state 5-1, an MCS_6_x table is selected to determine the modulation and coding scheme.

In a case where the fifth indication signaling is in a state 5-2, in response to fifth MCS-2 indication signaling being set to be in a state mcs-5-1, an MCS_6_x table is selected to determine the modulation and coding scheme.

In a case where the fifth indication signaling is in the state 5-2, in response to fifth MCS-2 indication signaling being set to be in a state mcs-5-2, an MCS_U_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the fifth indication signaling indicates the fifth MCS-1 table indication signaling or the fifth MCS-2 indication signaling, the state 5-1 is that the fifth MCS-1 table indication signaling is valid, or is an absent state or a default state, and the state 5-2 is that the fifth MCS-2 indication signaling is valid.

Alternatively, the fifth indication signaling indicates the fifth MCS-1 table indication signaling or the fifth MCS-2 indication signaling, the state 5-1 is that the fifth MCS-1 table indication signaling is valid, and the state 5-2 is that the fifth MCS-2 indication signaling is valid, or is an absent state or is a default state.

Alternatively, the fifth MCS-2 indication signaling is BLER-target indication signaling, the state mcs-5-1 is 10⁻¹, an absent state or a default state and mcs-5-1 is 10⁻⁵, or the state mcs-5-1 is 10⁻¹ and mcs-5-1 is 10⁻⁵, an absent state or a default state.

In an embodiment of the present disclosure, the fifth MCS-2 indication signaling indicates that the MCS_U_x table or MCS_6_x table is valid, the state mcs-5-1 is that the MCS_6_x table indication signaling is valid, or is an absent state or is a default state, and the state mcs-5-2 is that MCS_U_x table indication signaling is valid.

Alternatively, the fifth MCS-2 indication signaling indicates that the MCS_U_x table or the MCS_6_x table is valid, the state mcs-5-1 is that the MCS_6_x table indication signaling is valid, and the state mcs-5-2 is that the MCS_U_x table indication signaling is valid, or is an absent state or is a default state.

In an embodiment of the present disclosure, the fifth indication signaling is BLER-target indication signaling, the state 5-1 is 10⁻¹, an absent state or a default state and the state 5-2 is 10⁻⁵, or the state 5-1 is 10⁻¹ and the state 5-2 is 10⁻⁵, an absent state or a default state.

Alternatively, the fifth indication signaling is URLLC indication signaling indicating whether URLLC is supported, the state 5-1 is that the URLLC is not supported, and the state 5-2 is that the URLLC is supported.

In an embodiment of the present disclosure, the higher-layer configuration signaling includes sixth indication signaling and sixth MCS table indication signaling.

In a case where transmission data satisfies a first condition, selecting an MCS table to determine a modulation and coding scheme at least includes one of cases described below.

In a case where the sixth indication signaling is in a state 6-1, in response to the sixth MCS table indication signaling being set to 256QAM, the MCS_8 table is selected to determine the modulation and coding scheme; in response to the sixth MCS table indication signaling being set to 64QAM, an MCS_6_x table is selected to determine the modulation and coding scheme; and in response to the sixth MCS table indication signaling being in another state, an MCS_6_x table is selected to determine the modulation and coding scheme.

In a case where the sixth indication signaling is in a state 6-2, in response to the sixth MCS table indication signaling being set to 256QAM, the MCS_8 table is selected to determine the modulation and coding scheme; in response to the sixth MCS table indication signaling being set to 64QAM, an MCS_6_x table is selected to determine the modulation and coding scheme; and in response to the sixth MCS table indication signaling being in another state, an MCS_U_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the higher-layer configuration signaling includes sixth indication signaling; and in a case where transmission data satisfies a second condition, selecting an MCS table to determine a modulation and coding scheme at least includes one of cases described below.

An MCS_6_x table is selected to determine the modulation and coding scheme.

In a case where the sixth indication signaling is in a state 6-1, an MCS_6_x table is selected to determine the modulation and coding scheme.

In a case where the sixth indication signaling is in a state 6-2, an MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the sixth indication signaling is BLER-target indication signaling, the state 6-1 is 10⁻¹, an absent state or a default state and the state 6-2 is 10⁻⁵, or the state 6-1 is 10⁻¹ and the state 6-2 is 10⁻⁵, an absent state or a default state.

Alternatively, the sixth indication signaling is URLLC indication signaling indicating whether URLLC is supported, the state 6-1 is that the URLLC is not supported, and the state 6-2 is that the URLLC is supported.

Alternatively, the sixth indication signaling is a configuration parameter indicating whether MCS_U_x is supported, the state 6-2 is that MCS_U_x of URLLC is supported and the state 6-1 is a state other than the state 6-2, or the state 6-2 is that MCS_U_x is supported, is an absent state or a default state and the state 6-1 is a state other than the state 6-2.

In an embodiment of the present disclosure, the higher-layer configuration signaling includes seventh indication signaling and seventh MCS table indication signaling; and in a case where transmission data satisfies a first condition, selecting an MCS table to determine a modulation and coding scheme at least includes one of cases described below.

In a case where the seventh indication signaling is in a state 7-1, an MCS_6_x table is selected to determine the modulation and coding scheme.

In a case where the seventh indication signaling is in a state 7-2, an MCS_U_x table is selected to determine the modulation and coding scheme.

In a case where the seventh indication signaling is in a state 7-3, in response to the seventh MCS table indication signaling being set to 256QAM, the MCS_8 table is selected to determine the modulation and coding scheme; in response to the seventh MCS table indication signaling being set to 64QAM, an MCS_6_x table is selected to determine the modulation and coding scheme; and in response to the seventh MCS table indication signaling being in another state, an MCS_U_x table is selected to determine the modulation and coding scheme.

In a case where the seventh indication signaling is in a state 7-3, in response to the seventh MCS table indication signaling being set to 256QAM, the MCS_8 table is selected to determine the modulation and coding scheme; in response to the seventh MCS table indication signaling being set to 64QAM, an MCS_6_x table is selected to determine the modulation and coding scheme; and in response to the seventh MCS table indication signaling being in another state, an MCS_6_x table is selected to determine the modulation and coding scheme.

In a case where the seventh indication signaling is in a state 7-1, in response to the seventh MCS table indication signaling being set to 256QAM, the MCS_8 table is selected to determine the modulation and coding scheme; in response to the seventh MCS table indication signaling being set to 64QAM, an MCS_6_x table is selected to determine the modulation and coding scheme; and in response to the seventh MCS table indication signaling being in another state, the MCS_6_x table is selected to determine the modulation and coding scheme.

In a case where the seventh indication signaling is in a state 7-2, in response to the seventh MCS table indication signaling being set to 256QAM, the MCS_8 table is selected to determine the modulation and coding scheme; in response to the seventh MCS table indication signaling being set to 64QAM, an MCS_6_x table is selected to determine the modulation and coding scheme; and in response to the seventh MCS table indication signaling being in another state, an MCS_U_x table is selected to determine the modulation and coding scheme.

In a case where the seventh indication signaling is in a state 7-3, in response to the seventh MCS table indication signaling being set to 256QAM, the MCS_8 table is selected to determine the modulation and coding scheme; in response to the seventh MCS table indication signaling being set to 64QAM, an MCS_6_x table is selected to determine the modulation and coding scheme; and in response to the seventh MCS table indication signaling being in another state, an MCS_U_x table is selected to determine the modulation and coding scheme.

In a case where the seventh indication signaling is in a state 7-3, in response to the seventh MCS table indication signaling being set to 256QAM, the MCS_8 table is selected to determine the modulation and coding scheme; in response to the sixth MCS table indication signaling being set to 64QAM, an MCS_6_x table is selected to determine the modulation and coding scheme; and in response to the sixth MCS table indication signaling being in another state, the MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the higher-layer configuration signaling includes seventh indication signaling; and in a case where transmission data satisfies a second condition, selecting an MCS table to determine a modulation and coding scheme at least includes one of cases described below.

An MCS_6_x table is selected to determine the modulation and coding scheme.

In a case where the seventh indication signaling is in a state 7-2, an MCS_U_x table is selected to determine the modulation and coding scheme.

In a case where the seventh indication signaling is not in the state 7-2, an MCS_6_x table is selected to determine the modulation and coding scheme.

The MCS_6_x table is the MCS_6 table or the MCS_6 BPSK, and the MCS_U_x table is the MCS_U table or the MCS_U_BPSK table.

In an embodiment of the present disclosure, the seventh indication signaling is BLER-target indication signaling, the state 7-1 is 10⁻¹, the state 7-2 is 10⁻⁵, and the state 7-3 is an absent state or a default state.

In an embodiment of the present disclosure, in a case where the transmission link direction is downlink, the first condition includes at least one of conditions described below.

The downlink control signaling format is DCI format 1_1, and the downlink control signaling carries the modulation and coding scheme field.

The CRC scrambling method corresponding to the downlink control signaling is scrambled by a cell-radio network temporary identifier (C-RNTI), and the downlink control signaling carries the modulation and coding scheme field.

The CRC scrambling method corresponding to the downlink control signaling is scrambled by a configured scheduling radio network temporary identifier (CS-RNTI), and the downlink control signaling carries the modulation and coding scheme field.

The second condition includes at least one of conditions described below.

The downlink control signaling format is DCI format 1_0, and the downlink control signaling carries the modulation and coding scheme field.

The CRC scrambling method corresponding to the downlink control signaling is not scrambled by the C-RNTI and/or the CS-RNTI, and the downlink control signaling carries the modulation and coding scheme field.

The MCS_6_x table is the MCS_6 table.

The MCS_U_x table is the MCS_U table.

In an embodiment of the present disclosure, in a case where the transmission link direction is uplink, the first condition includes at least one of conditions described below.

Transform precoding is disabled.

The downlink control signaling format is DCI format 0_1, and the downlink control signaling carries the modulation and coding scheme field.

The CRC scrambling method corresponding to the downlink control signaling is scrambled by a C-RNTI, and the downlink control signaling carries a modulation and coding scheme field.

The CRC scrambling method corresponding to the downlink control signaling is scrambled by a CS-RNTI, and the downlink control signaling carries a modulation and coding scheme field.

The CRC scrambling method corresponding to the downlink control signaling is scrambled by a semi-persistent CSI radio network temporary identifier (SP-CSI-RNTI), and the downlink control signaling carries the modulation and coding scheme field.

In a case where the transmission link direction is uplink, the second condition includes at least one of conditions described below.

Transform precoding is disabled.

The downlink control signaling format is DCI format 0_0, and the downlink control signaling carries the modulation and coding scheme field.

The CRC scrambling method corresponding to the downlink control signaling is not scrambled by C-RNTI and/or the CS-RNTI and/or the SP-CSI-RNT, and the downlink control signaling carries the modulation and coding scheme field.

The MCS_6_x table is the MCS_6 table.

The MCS_U_x table is the MCS_U table.

In an embodiment of the present disclosure, in a case where the transmission link direction is uplink, the first condition includes at least one of conditions described below.

Transform precoding is enabled.

The downlink control signaling format is DCI format 0_1, and the downlink control signaling carries the modulation and coding scheme field.

The CRC scrambling method corresponding to the downlink control signaling is scrambled by a C-RNTI, and the downlink control signaling carries the modulation and coding scheme field.

The CRC scrambling method corresponding to the downlink control signaling is a scrambled by CS-RNTI, and the downlink control signaling carries the modulation and coding scheme field.

The CRC scrambling method corresponding to the downlink control signaling is scrambled by SP-CSI-RNTI, and the downlink control signaling carries the modulation and coding scheme field.

In a case where the transmission link direction is uplink, the second condition includes at least one of conditions described below.

Transform precoding is enabled.

The downlink control signaling format is DCI format 0_0, and the downlink control signaling carries the modulation and coding scheme field.

The CRC scrambling method corresponding to the downlink control signaling is not scrambled by the C-RNTI and/or the CS-RNTI and/or the SP-CSI-RNTI, and the downlink control signaling carries the modulation and coding scheme field.

The MCS_6_x table is the MCS_6 BPSK table.

The MCS_U_x table is the MCS_U_BPSK table.

In an embodiment of the present disclosure, in a case where the downlink control signaling format includes at least DCI format 1_0 And the downlink control signaling carries the modulation and coding scheme field, selecting the MCS table to determine the modulation and coding scheme further includes cases described below.

The MCS_6 table is selected to determine the modulation and coding scheme.

The MCS_6 table or the MCS_U table is selected according to a predetermined condition to determine the modulation and coding scheme.

In an embodiment of the present disclosure, in a case where the downlink control signaling format at least includes DCI format 0_0 and the downlink control signaling carries the modulation and coding scheme field, selecting the MCS table to determine the modulation and coding scheme at least includes one of cases described below.

The MCS_6 table is selected to determine the modulation and coding scheme; or the MCS_6 table or the MCS_U table is selected according to a predetermined condition to determine the modulation and coding scheme.

In a case where transform precoding is disabled, selecting the MCS table to determine the modulation and coding scheme further includes: the MCS_6 table is selected to determine the modulation and coding scheme; or the MCS_6 table or the MCS_U table is selected according to a predetermined condition to determine the modulation and coding scheme.

In a case where the transform precoding is enabled, selecting the MCS table to determine the modulation and coding scheme further includes cases described below.

The MCS_6 BPSK table is selected to determine the modulation and coding scheme; or the MCS_6 BPSK table or the MCS_U_BPSK table is selected according to a predetermined condition to determine the modulation and coding scheme.

In an embodiment of the present disclosure, the predetermined condition at least relates to one of: a UE capability; a UE category; or higher-layer configuration signaling.

In an embodiment of the present disclosure, the higher-layer configuration signaling at least includes the BLER-target indication signaling.

To solve the above-mentioned technical problem, an embodiment of the present disclosure provides a channel quality indicator (CQI) reporting method. The method includes steps described below.

A CQI index is selected and transmission is performed on an uplink channel.

The CQI index satisfies that a transport block is coded and modulated according to a modulation and coding scheme indicated by the CQI index in a CQI table, and then transmitted on a downlink channel, and a block error rate of the transport block does not exceed a preset value.

The CQI table is selected from a CQI table set according to a predefined mode.

To solve the above-mentioned technical problem, an embodiment of the present disclosure further provides a modulation and coding apparatus. The apparatus includes an information acquisition module and a first processing module.

The information acquisition module is configured to select a modulation and coding scheme (MCS) table from an MCS table set according to a predefined rule.

The first processing module is configured to determine a modulation order and a target code rate according to the selected MCS table and a modulation and coding scheme field read from downlink control signaling.

The MCS table set includes an MCS table supporting a minimum spectral efficiency less than 120/1024*2.

To solve the above-mentioned technical problem, an embodiment of the present disclosure provides a CQI reporting apparatus. The apparatus includes a second processing module.

The second processing module is configured to select a CQI index and perform transmission on an uplink channel.

The CQI index satisfies that a transport block is modulated and coded according to a modulation and coding scheme indicated by the CQI index in a CQI table and then transmitted on a downlink channel, and a block error rate of the transport block does not exceed a preset value.

The CQI table is selected from a CQI table set according to a predefined mode.

To solve the above-mentioned technical problem, an embodiment of the present disclosure further provides a base station. The base station includes a first processor, a first memory and a first communications bus.

The first communications bus is configured to implement communication connection between the first processor and the first memory.

The processor is configured to execute one or more first programs stored in the first memory, so as to implement steps of the above-mentioned modulation and coding method.

Alternatively, the first processor is configured to execute one or more second programs stored in the first memory, so as to implement steps of the above-mentioned CQI reporting method.

To solve the above-mentioned technical problem, an embodiment of the present disclosure further provides a terminal. The terminal includes a second processor, a second memory and a second communications bus.

The second communications bus is configured to implement communication connection between the second processor and the second memory.

The second processor is configured to execute one or more second programs stored in the second memory, so as to implement steps of the above-mentioned modulation and coding method.

Alternatively, the second processor is configured to execute one or more second programs stored in the second memory, so as to implement steps of the above-mentioned CQI reporting method.

To solve the above-mentioned technical problem, an embodiment of the present disclosure further provides a computer-readable storage medium, where the computer-readable storage medium stores one or more first programs executable by one or more processors, so as to implement steps of the above-mentioned modulation and coding method.

Alternatively, the computer-readable storage medium stores one or more second programs executable by one or more processors, so as to implement steps of the above-mentioned CQI.

The present disclosure has beneficial effects described below.

According to a modulation and coding method and apparatus and a channel quality indicator (CQI) reporting method and apparatus, a device and a storage medium provided by the present disclosure, in an MCS table set, an MCS table supporting a minimum spectral efficiency less than 120/1024*2 is added, and a selecting rule of an MCS table is provided. Therefore, compared with an MCS table set in the related protocols, communications requirements of higher reliability, higher coverage and lower transmission rate can be satisfied. Moreover, the embodiments of the present disclosure further provide a CQI reporting method and apparatus, a device and a storage medium to accurately satisfy current communications requirements, especially the communications requirements of higher reliability, higher coverage and lower transmission rate.

In an embodiment, the MCS_U table supporting a minimum spectral efficiency of less than 120/1024*2 provided by embodiments of the present disclosure may include an MCS_U_BPSK table supporting a minimum modulation order of 1 or 2 and an MCS_U table supporting a minimum modulation order of 2 to better satisfy requirements of various communications scenarios.

Further, the MCS_U table and the MCS_U_BPSK table provided by the embodiments of the present disclosure support a minimum spectral efficiency greater than or equal to 30/1024*2 and less than or equal to 50/1024*2, so as to satisfy communications requirements of services such as URLLC.

Other features of the present disclosure and corresponding beneficial effects are set forth later in the description, and it should be understood that at least part of the beneficial effects become apparent from the description of the present disclosure.

### BRIEF DESCRIPTION OF DRAWINGS

FIG. 1 is a flowchart of a modulation and coding method according to embodiment one of the present disclosure;

FIG. 2 is a flowchart of selecting an MCS table to determine a modulation and coding scheme according to embodiment one of the present disclosure;

FIG. 3 is a structural diagram of a modulation and coding apparatus according to embodiment three of the present disclosure;

FIG. 4 is a structural diagram of a CQI reporting apparatus according to embodiment three of the present disclosure;

FIG. 5 is a structural diagram of a base station according to embodiment three of the present disclosure; and

FIG. 6 is a structural diagram of a terminal according to embodiment three of the present disclosure.

### DETAILED DESCRIPTION

In order to satisfy communications requirements of higher reliability, higher coverage and lower transmission rate, for a modulation and coding method provided in the embodiments, an MCS table supporting a minimum spectral efficiency less than 120/1024*2, which is less than minimum spectral efficiencies supported by MCS tables supported by the related protocols, is added to an MCS table set so that an appropriate modulation and coding scheme can be determined to better satisfy the communications requirements of higher reliability, higher coverage and lower transmission rate.

Optionally, in an embodiment, an MCS_U table and an MCS_U_BPSK table are added in the MSC table combination, and the minimum spectral efficiency supported by the added MCS_U table and the minimum spectral efficiency supported by the added MCS_U_BPSK are both less than 120/1024*2.

Optionally, to implement a downlink adaptive modulation and coding technology, control signaling including channel state information (CSI) may be transmitted in the uplink, where a channel quality indicator (CQI) is included. A base station performs scheduling in combination with the CQI reported by a terminal and determines a downlink modulation and coding scheme. Optionally, to implement an uplink adaptive modulation and coding technology, the base station may also determine an uplink modulation and coding scheme through a reference signal (for example, including but not limited to a sounding reference signal (SRS)).

Optionally, a CQI reporting method is also provided in the embodiments, optionally, a CQI_U table supporting a minimum spectral efficiency less than or equal to 50/1024*2 is added among CQI tables, and a CQI table selecting mode is provided, so as to better satisfy current communications requirements, especially the communications requirements of higher reliability, higher coverage and lower transmission rate.

### Embodiment One

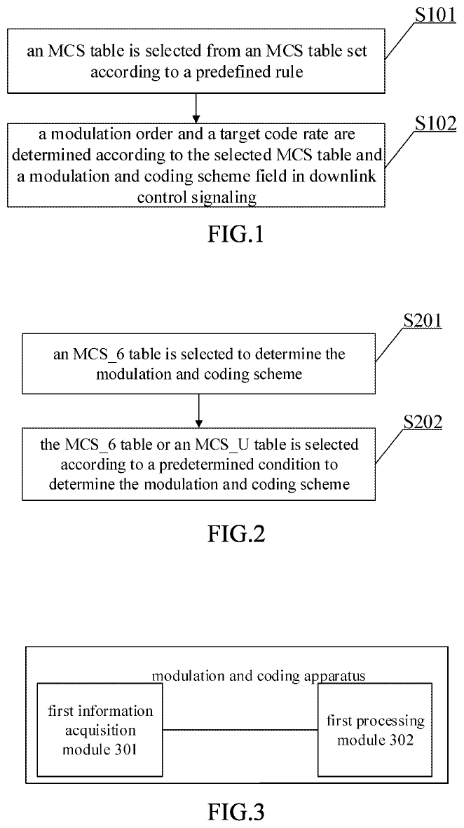

To facilitate understanding, referring to FIG. 1, an MCS table acquisition method provided by the embodiment includes steps described below.

In S101, an MCS table is selected from an MCS table set according to a predefined rule.

In S102, a modulation order and a target code rate are determined according to the selected MCS table and a modulation and coding scheme field in downlink control signaling.

The MCS table set includes an MCS table supporting a minimum spectral efficiency less than 120/1024*2.

Optionally, in an embodiment, the MCS table set at least includes the following three MCS tables: an MCS_6 table supporting a maximum modulation order of 6, a minimum modulation order of 2, a maximum spectral efficiency of 948/1024*6 and a minimum spectral efficiency of 120/1024*2; an MCS_8 table supporting a maximum modulation order of 8, a minimum modulation order of 2, a maximum spectral efficiency of 948/1024*8 and a minimum spectral efficiency of 120/1024*2; and an MCS_U table supporting a maximum modulation order of 6, a minimum modulation order of 2, a maximum spectral efficiency not greater than 772/1024*6 and a minimum spectral efficiency greater than or equal to 30/1024*2 and less than or equal to 50/1024*2.

In an embodiment, the MCS table set at least includes the following three MCS tables: an MCS 6 BPSK table supporting the maximum modulation order of 6, a minimum modulation order of 1 or 2, a maximum spectral efficiency of 948/1024*6 and a minimum spectral efficiency of 120/1024*2; the MCS_8 table supporting a maximum modulation order of 8, a minimum modulation order of 2, a maximum spectral efficiency of 948/1024*8 and a minimum spectral efficiency of 120/1024*2; and an MCS_U_BPSK table supporting a maximum modulation order of 6, a minimum modulation order of 1 or 2, a maximum spectral efficiency not greater than 772/1024*6 and a minimum spectral efficiency greater than or equal to 30/1024*2 and less than or equal to 50/1024*2.

In an embodiment, an MCS_6 BPSK table supporting a minimum modulation order of 1 or 2 refers to that for a UE reporting not supporting transform precoding or reporting not supporting pi/2 BPSK modulation, the minimum modulation order of the MCS_6 BPSK table is 2, and otherwise, the minimum modulation order of the MCS_6 BPSK table is 1.

In an embodiment, an MCS_U_BPSK table supporting a minimum modulation order of 1 or 2 refers to that for a UE reporting not supporting transform precoding or reporting not supporting pi/2 BPSK modulation, the minimum modulation order of the MCS_U_BPSK table is 2, and otherwise, the minimum modulation order of the MCS_U_BPSK table is 1.

In an embodiment, an exemplary MCS_6 table is shown in Table 2. In an embodiment, an exemplary MCS_8 table is shown in Table 3. In an embodiment, an exemplary MCS_6 BPSK table is shown in Table 4.

It should be understood that Tables 2, 3 and 4 respectively show merely one example of the MCS_6 table, one example of the MCS_8 table, and one example of the MCS_6 BPSK table in the embodiment, and the MCS_6 table, MCS_8 table, and MCS_6 BPSK table are not limited to those shown in the Tables 2, 3, and 4. Moreover, specific values of the maximum spectral efficiency and the minimum spectral efficiency of the MCS_U in the embodiment may be flexibly set according to specific communications scenarios/requirements.

TABLE 2

| MCS | Modulation | Target code Rate | Spectral |
|---|---|---|---|
| Index IMCS | Order Qm | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

TABLE 3

| MCS | Modulation | Target code Rate | Spectral |
|---|---|---|---|
| Index IMCS | Order Qm | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 8 | reserved |

TABLE 4

| MCS | Modulation | Target code Rate | Spectral |
|---|---|---|---|
| Index IMCS | Order Qm | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

In the embodiment, the predefined rule at least relates to (but not limited to) one of: a link direction including at least one of an uplink direction or a downlink direction; higher-layer configuration signaling; a user category or a user capability; a downlink control signaling format including at least DCI format 1_0, DCI format 1_1, DCI format 0_0 and DCI format 0_0, where the downlink control signaling carries a modulation and coding scheme field; a cyclic redundancy check (CRC) scrambling method corresponding to the downlink control signaling, where the downlink control signaling carries the modulation and coding scheme field and where the scrambling method includes a cell-radio network temporary identifier (C-RNTI) scrambling method, a configured scheduling RNTI (CS-RNTI) scrambling method, an interruption RNTI (INT-RNTI) scrambling method, a slot format indication RNTI (SFI-RNTI) scrambling method, a semi-persistent CSI RNTI (SP-CSI-RNTI) scrambling method, a transmit power control-configured scheduling-RNTI (TPC-CS-RNTI) scrambling method and a transmit power control-sounding reference symbols-RNTI (TPC-SRS-RNTI) scrambling method; a channel quality indicator table corresponding to a reported channel quality indicator; a predefined subcarrier spacing set including at least one of 15 kHZ, 30 kHZ, 60 kHZ or 120 kHZ; a predefined time domain resource mapping method including at least the number of symbols is 2, 4, 7 and 14; a predefined frequency domain resource set including a resource other than the resource that may be subjected to high interference among spectral resources and the resource that may be subjected to high interference among spectral resources; a predefined antenna port set; and a predefined set of numbers of transmission layers, which is a subset of transmission layer {1, . . . , 8}.

Optionally, in an embodiment, the predefined rule may be set to relate to: the link direction, the higher-layer configuration signaling; the downlink control signaling format, where the downlink control signaling carries the modulation and coding scheme field; and the CRC scrambling method corresponding to the downlink control signaling, where the downlink control signaling carries the modulation and coding scheme field.

To facilitate understanding of the present disclosure, the present disclosure is further described below in conjunction with the embodiment and several specific examples.

### Example One

In a case where data satisfies a first condition, selecting an MCS table to determine a modulation and coding scheme at least includes one of the cases described below.

(1.1) In a case where first indication signaling is in a state 1-1, in response to first MCS table indication signaling being set to 256 QAM, the MCS_8 table is selected to determine the modulation and coding scheme, and in response to the first MCS table indication signaling being not set to 256QAM, an MCS_6_X table is selected to determine the modulation and coding scheme.

(1.2) In a case where first indication signaling is in a state 1-1, an MCS_6_X table is selected to determine the modulation and coding scheme.

(1.3) In a case where first indication signaling is in a state 1-2, in response to first MCS table indication signaling being set to 256QAM, the MCS_8 table is selected to determine the modulation and coding scheme, and in response to the first MCS table indication signaling being not set to 256QAM, an MCS_U_X table is selected to determine the modulation and coding scheme.

(1.4) In a case where first indication signaling is in a state 1-2, an MCS_U_X table is selected to determine the modulation and coding scheme.

(1.5) In a case where first indication signaling is in a state 1-3, in response to first MCS table indication signaling being set to 256QAM, the MCS_8 table is selected to determine the modulation and coding scheme, and in response to the first MCS table indication signaling being not set to 256QAM, an MCS_6_X table is selected to determine the modulation and coding scheme.

(1.6) In a case where first indication signaling is in a state 1-3, an MCS_6_X table is selected to determine the modulation and coding scheme.

In a case where downlink data satisfies the first condition, selecting an MCS table to determine a modulation and coding scheme can be achieved through any combination of (1.1) to (1.6) according to a state of the first indication signaling. Table 1.1 to Table 1.4 are modes for determining a downlink MCS table in different states of the first indication signaling and first MCS table indication signaling obtained through the above-mentioned combination mode.

For example, in the Table 1.1, in a case where data satisfies the first condition and in a case where first indication signaling is in a state 1-1, an MCS_6_X table is selected to determine the modulation and coding scheme.

In a case where the first indication signaling is in a state 1-2, an MCS_U_X table is selected to determine the modulation and coding scheme.

In a case where the first indication signaling is in a state 1-3, in response to first MCS table indication signaling being set to 256QAM, the MCS_8 table is selected to determine the modulation and coding scheme, and in response to the first MCS table indication signaling being not set to 256QAM, an MCS_6_X table is selected to determine the modulation and coding scheme.

For example, in Table 1.2, in a case where data satisfies the first condition and in a case where first indication signaling is in a state 1-1, in response to first MCS table indication signaling being set to 256QAM, the MCS_8 table is selected to determine the modulation and coding scheme, and in response to the first MCS table indication signaling being not set to 256QAM, an MCS_6_X table is selected to determine the modulation and coding scheme.

In a case where first indication signaling is in a state 1-2, an MCS_U_X table is selected to determine the modulation and coding scheme.

In a case where first indication signaling is in a state 1-3, an MCS_6_X table is selected to determine the modulation and coding scheme.

For example, in Table 1.3, in a case where data satisfies the first condition and in a case where first indication signaling is in a state 1-1, in response to first MCS table indication signaling being set to 256QAM, the MCS_8 table is selected to determine the modulation and coding scheme, and in response to the first MCS table indication signaling being not set to 256QAM, an MCS_6_X table is selected to determine the modulation and coding scheme.

In a case where first indication signaling is in a state 1-2, an MCS_U_X table is selected to determine the modulation and coding scheme.

In a case where first indication signaling is in a state 1-3, in response to first MCS table indication signaling being set to 256QAM, the MCS_8 table is selected to determine the modulation and coding scheme, and in response to the first MCS table indication signaling being not set to 256QAM, an MCS_6_X table is selected to determine the modulation and coding scheme.

For example, in Table 1.4, in a case where data satisfies the first condition and in a case where first indication signaling is in a state 1-1, in response to first MCS table indication signaling being set to 256QAM, the MCS_8 table is selected to determine the modulation and coding scheme, and in response to the first MCS table indication signaling being not set to 256QAM, an MCS_6_X table is selected to determine the modulation and coding scheme.

In a case where first indication signaling is in a state 1-2, in response to first MCS table indication signaling being set to 256QAM, the MCS_8 table is selected to determine the modulation and coding scheme, and in response to the first MCS table indication signaling being not set to 256QAM, an MCS_U_X table is selected to determine the modulation and coding scheme.

In a case where first indication signaling is in a state 1-3, an MCS_6_X table is selected to determine the modulation and coding scheme.

TABLE 1.1

First MCS table indication signaling

| | | 256QAM | Others |
|---|---|---|---|
| First | State 1-1 | MCS_6_X | MCS_6_X |
| indication | | table | table |
| signaling | State 1-2 | MCS_U_X | MCS_U_X |
| | | table | table |
| | State 1-3 | MCS_8 | MCS_6_X |
| | | table | table |

TABLE 1.2

First MCS table indication signaling

| | | 256QAM | Others |
|---|---|---|---|
| First | State 1-1 | MCS_8 | MCS_6_X |
| indication | | table | table |
| signaling | State 1-2 | MCS_U_X | MCS_U_X |
| | | table | table |
| | State 1-3 | MCS_6_X | MCS_6_X |
| | | table | table |

TABLE 1.3

First MCS table indication signaling

| | | 256QAM | Others |
|---|---|---|---|
| First | State 1-1 | MCS_8 | MCS_6_X |
| indication | | table | table |
| signaling | State 1-2 | MCS_U_X | MCS_U_X |
| | | table | table |
| | State 1-3 | MCS_8 | MCS_6_X |
| | | table | table |

TABLE 1.4

First MCS table indication signaling

| | | 256QAM | Others |
|---|---|---|---|
| First | State 1-1 | MCS_8 | MCS_6_X |
| indication | | table | table |
| signaling | State 1-2 | MCS_8 | MCS_U_X |
| | | table | table |
| | State 1-3 | MCS_6_X | MCS_6_X |
| | | table | table |

### Example Two

In a case where data satisfies a second condition, selecting an MCS table to determine a modulation and coding scheme at least includes one of the cases described below.

(2.1) An MCS_6_X table is selected to determine the modulation and coding scheme.

(2.2) In a case where first indication signaling is in a state 1-2, an MCS_U_X table is selected to determine the modulation and coding scheme; in a case where the first indication signaling is not set to be in the state 1-2, an MCS_6_X table is selected to determine the modulation and coding scheme.

The (2.1) indicates that the modulation and coding scheme is determined according to the MCS_6_X table as long as downlink data satisfies the second condition without considering states of the first indication signaling and first MCS table indication signaling.

A mode for determining a downlink MCS table of (2.2) is shown in Table 2.1.

In the Table 2.1, in a case where data satisfies the second condition and in a case where first indication signaling is in a state 1-1, an MCS_6_X table is selected to determine the modulation and coding scheme; in a case where the first indication signaling is in a state 1-2, an MCS_U_X table is selected to determine the modulation and coding scheme.

TABLE 2.1

| | | |
|---|---|---|
| First | State 1-1 | MCS_6_X |
| indication | | table |
| signaling | State 1-2 | MCS_U_X |
| | | table |

It is to be noted that the example one and the example two may be used in any combination to determine the modulation and coding scheme in a case where downlink data satisfies the first condition and the second condition.

It is to be noted that the first indication signaling is block error rate-target (BLER-target) indication signaling, the state 1-1 is 10⁻¹, the state 1-2 is 10⁻⁵, and the state 1-3 is an absent state or a default state.

### Example Three

In a case where transmission data satisfies a first condition, selecting an MCS table to determine a modulation and coding scheme at least includes one of the cases described below.

(3.1) In a case where second indication signaling is in a state 2-1, in response to second MCS table indication signaling being set to 256QAM, the MCS_8 table is selected to determine the modulation and coding scheme, and in response to the second MCS table indication signaling being not set to 256QAM, an MCS_6_X table is selected to determine the modulation and coding scheme.

(3.2) In a case where second indication signaling is in a state 2-1, an MCS_6_X table is selected to determine the modulation and coding scheme.

(3.3) In a case where second indication signaling is in a state 2-2, in response to second MCS table indication signaling being set to 256QAM, the MCS_8 table is selected to determine the modulation and coding scheme, and in response to the second MCS table indication signaling being not set to 256QAM, an MCS_U_X table is selected to determine the modulation and coding scheme.

(3.4) In a case where second indication signaling is in a state 2-2, an MCS_U_X table is selected to determine the modulation and coding scheme.

In a case where downlink data satisfies the first condition, selecting an MCS table to determine a modulation and coding scheme can be achieved through any combination of (3.1) and (3.1) or of (3.1) and (3.4), or be achieved through any combination of (3.2) and (3.3) or of (3.2) and (3.4). Table 3.1, Table 3.2 and Table 3.3 are modes for determining a downlink MCS table in different states of the second indication signaling and the second MCS table indication signaling obtained through the above-mentioned combination modes.

For example, in Table 3.1, in a case where data satisfies the first condition and in a case where second indication signaling is in a state 2-1, in response to second MCS table indication signaling being set to 256QAM, the MCS_8 table is selected to determine the modulation and coding scheme, and in response to the second MCS table indication signaling being not set to 256QAM, an MCS_6_X table is selected to determine the modulation and coding scheme.

In a case where second indication signaling is in a state 2-2, an MCS_U_X table is selected to determine the modulation and coding scheme.

For example, in Table 3.2, in a case where downlink data satisfies the first condition and in a case where second indication signaling is in a state 2-1, in response to second MCS table indication signaling being set to 256QAM, the MCS_8 table is selected to determine the modulation and coding scheme, and in response to the second MCS table indication signaling being not set to 256QAM, an MCS_6_X table is selected to determine the modulation and coding scheme.

In a case where second indication signaling is in a state 2-2, in response to second MCS table indication signaling being set to 256QAM, the MCS_8 table is selected to determine the modulation and coding scheme, and in response to the second MCS table indication signaling being not set to 256QAM, an MCS_U_X table is selected to determine the modulation and coding scheme.

For example, in Table 3.3, in a case where downlink data satisfies the first condition and in a case where second indication signaling is in a state 2-1, an MCS_6_X table is selected to determine the modulation and coding scheme.

In a case where second indication signaling is in a state 2-2, in response to second MCS table indication signaling being set to 256QAM, the MCS_8 table is selected to determine the modulation and coding scheme, and in response to the second MCS table indication signaling being not set to 256QAM, an MCS_U_X table is selected to determine the modulation and coding scheme.

TABLE 3.1

| | | Second MCS table indication signaling | |
|---|---|---|---|
| | | 256QAM | Others |
| Second | State 2-1 | MCS_8 | MCS_6_X |
| indication | | table | table |
| signaling | State 2-2 | MCS_U_X | MCS_U_X |
| | | table | table |

TABLE 3.2

| | | Second MCS table indication signaling | |
|---|---|---|---|
| | | 256QAM | Others |
| Second | State 2-1 | MCS_8 | MCS_6_X |
| indication | | table | table |
| signaling | State 2-2 | MCS_8 | MCS_U_X |
| | | table | table |

TABLE 3.3

| | | Second MCS table indication signaling | |
|---|---|---|---|
| | | 256QAM | Others |
| Second | State 2-1 | MCS_6_X | MCS_6_X |
| indication | | table | table |
| signaling | State 2-2 | MCS_8 | MCS_U_X |
| | | table | table |

### Example Four

In a case where a second condition is satisfied, selecting an MCS table to determine a modulation and coding scheme includes cases described below.

(4.1) An MCS_6_X table is selected to determine the modulation and coding scheme.

(4.2) In a case where second indication signaling is in a state 2-1, an MCS_6_X table is selected to determine the modulation and coding scheme; in a case where the second indication signaling is in a state 2-2, an MCS_U_X table is selected to determine the modulation and coding scheme.

The (4.1) indicates that the modulation and coding scheme is determined according to the MCS_6_X table as long as data satisfies the second condition without considering states of the second indication signaling and second MCS table indication signaling.

A mode for determining a downlink MCS table of (4.2) is shown in Table 4.1.

In the Table 4.1, in a case where data satisfies the second condition and in a case where second indication signaling is in a state 2-1, an MCS_6_X table is selected to determine the modulation and coding scheme; in a case where the second indication signaling is in a state 2-2, an MCS_U_X table is selected to determine the modulation and coding scheme.

TABLE 4.1

| | | |
|---|---|---|
| Second | state 2-1 | MCS_6_X |
| indication | | table |
| signaling | state 2-2 | MCS_U_X |
| | | table |

It is to be noted that the example one and the example two may be used in any combination to determine the modulation and coding scheme in a case where downlink data satisfies the first condition and the second condition.

It is to be noted that the second indication signaling is BLER-target indication signaling, the state 2-1 is 10⁻¹, an absent state or a default state and the state 2-2 is 10⁻⁵, or the state 2-1 is 10⁻¹ and the state 2-2 is 10⁻⁵, an absent state or a default state.

Alternatively, the state 2-1 of the second indication signaling is 10⁻¹, an absent state or a default state and the state 2-2 is 10⁻⁵, or the state 2-1 is 10⁻¹ and the state 2-2 is 10⁻⁵, an absent state or a default state.

Alternatively, the second indication signaling is ultra-reliable and low latency communications (URLLC) indication signaling indicating whether URLLC is supported, the state 2-1 is that the URLLC is not supported, and the state 2-2 is that the URLLC is supported.

Alternatively, the second indication signaling is indication signaling indicating whether the MCS_U_X is supported, the state 2-2 is that MCS_U_X of URLLC is supported and the state 2-1 is a state other than the state 2-2, or the state 2-2 is that MCS_U_X is supported, is an absent state or a default state and the state 2-1 is a state other than the state 2-2.

### Example Five

In a case where data satisfies a first condition, selecting an MCS table to determine a modulation and coding scheme is described below.

In a case where third MCS table indication signaling is in a state mcs-3-1, an MCS_6_X table is selected to determine the modulation and coding scheme, in a case where the third MCS table indication signaling is in a state mcs-3-2, the MCS_8 table is selected to determine the modulation and coding scheme, or in a case where the third MCS table indication signaling is in a state mcs-3-3, an MCS_U_X table is selected to determine the modulation and coding scheme.

### Example Six

In a case where downlink data satisfies a second condition, selecting an MCS table to determine a modulation and coding scheme at least includes one of the cases described below.

(6.1) An MCS_6_X table is selected to determine the modulation and coding scheme.

(6.2) In a case where third MCS table indication signaling is in a state mcs-3-3, an MCS_U_X table is selected to determine the modulation and coding scheme; in a case where the third MCS table indication signaling is not set to be in the state mcs-3-3, an MCS_6_X table is selected to determine the modulation and coding scheme.

The (6.1) indicates that the modulation and coding scheme is determined according to the MCS_6_X table as long as downlink data satisfies the second condition without considering states of the third MCS table indication signaling.

A mode for determining a downlink MCS table of (6.2) is shown in Table 6.1.

In the Table 6.1, in a case where downlink data satisfies the second condition and in a case where third MCS table indication signaling is in a state mcs-3-3, an MCS_U_X table is selected to determine the modulation and coding scheme; in a case where third MCS table indication signaling is not in the state mcs-3-3, an MCS_6_X table is selected to determine the modulation and coding scheme.

TABLE 6.1

| | | |
|---|---|---|
| Third MCS table | Not set to be in | MCS table |
| indication | state mcs-3-3 | MCS_6_X |
| signaling | State mcs-3-3 | MCS table |
| | | MCS_U_X |

It is to be noted that the example five and the example six may be used in any combination to determine the modulation and coding scheme in a case where downlink data satisfies the first condition and the second condition.

It is to be noted that in the example five and the example six, the state mcs-3-1 of the third MCS table indication signaling indicates the MCS_6_X table, where the state mcs-3-1 may be represented as 64QAM; the state mcs-3-2 indicates the MCS_8 table, where the state mcs-3-2 may be represented as 256QAM; and the state mcs-3-3 indicates the MCS_U_X, or is an absent state or a default state.

### Example Seven

In a case where data satisfies a first condition, selecting an MCS table to determine a modulation and coding scheme at least includes one of the cases described below.

(7.1) In a case where fourth indication signaling is in a state 4-1, an MCS_6_X table is selected to determine the modulation and coding scheme; in a case where the fourth indication signaling is in a state 4-2, an MCS_U_X table is selected to determine the modulation and coding scheme.

(7.2) In response to fourth MCS table indication signaling being set to 256QAM, the MCS_8 table is selected to determine the modulation and coding scheme; and in response to the fourth MCS table indication signaling being not set to 256QAM, an MCS_6_X table is selected to determine the modulation and coding scheme.

It is to be noted that in the example seven, in a case where downlink data satisfies the first condition and in a case where higher-layer signaling configures two parameters of the fourth indication signaling and the fourth MCS table indication signaling or a UE may acquire two parameters of the fourth indication signaling and the fourth MCS table indication signaling at the same time, a problem of ambiguity in MCS table selection occurs.

Therefore, in the case where higher-layer signaling configures two parameters of the fourth indication signaling and the fourth MCS table indication signaling or a UE may acquire two parameters of the fourth indication signaling and the fourth MCS table indication signaling at the same time, only one indication signaling, such as the fourth indication signaling, is considered to be valid or has a higher priority.

For example, in a case where data satisfies a first condition, selecting an MCS table to determine a modulation and coding scheme is described below.

In a case where fourth indication signaling is in a state 4-1, an MCS_6_X table is selected to determine the modulation and coding scheme.

In a case where fourth indication signaling is in a state 4-2, an MCS_U_X table is selected to determine the modulation and coding scheme.

Otherwise, in response to fourth MCS table indication signaling being set to 256QAM, the MCS_8 table is selected to determine the modulation and coding scheme, and in response to the fourth MCS table indication signaling being not set to 256QAM, an MCS_6_X table is selected to determine the modulation and coding scheme.

Alternatively, it is to be specified that the higher layer can only configure/transmit one parameter of the fourth indication signaling or the fourth MCS table indication signaling; or it is specified that the UE only desires to acquire/receive at most one parameter of the fourth indication signaling or the fourth MCS table indication signaling.

### Example Eight

In a case where downlink data satisfies a second condition, selecting an MCS table to determine a modulation and coding scheme includes cases described below.

(8.1) An MCS_6_X table is selected to determine the modulation and coding scheme.

(8.2) Alternatively, in a case where fourth indication signaling is in a state 4-2, an MCS_U_X table is selected to determine the modulation and coding scheme; in a case where the fourth indication signaling is not in the state 4-2, an MCS_6_X table is selected to determine the modulation and coding scheme.

The (8.1) indicates that the modulation and coding scheme is determined according to the MCS_6_X table as long as downlink data satisfies the second condition without considering states of the fourth indication signaling and fourth MCS table indication signaling.

A mode for determining a downlink MCS table of (8.2) is shown in Table 8.1.

In the Table 8.1, in a case where data satisfies the second condition and in a case where fourth indication signaling is in a state 4-1, an MCS_6_X table is selected to determine the modulation and coding scheme.

In a case where fourth indication signaling is in a state 4-2, an MCS_U_X table is selected to determine the modulation and coding scheme.

TABLE 8.1

| | | |
|---|---|---|
| Fourth | State 4-1 | MCS_6_X |
| indication | | table |
| signaling | State 4-2 | MCS_U_X |
| | | table |

It is to be noted that the example seven and the example eight may be used in any combination to determine the modulation and coding scheme in a case where downlink data satisfies the first condition and the second condition.

It is to be noted that the fourth indication signaling is BLER-target indication signaling, the state 4-1 is 10⁻¹, an absent state or a default state and the state 4-2 is 10⁻⁵, or the state 4-1 is 10⁻¹ and the state 4-2 is 10⁻⁵, an absent state or a default state.

Alternatively, the state 4-1 of the fourth indication signaling is 10⁻¹, an absent state or a default state and the state 4-2 is 10⁻⁵, or the state 4-1 is 10⁻¹ and the state 4-2 is 10⁻⁵, an absent state or a default state.

Alternatively, the fourth indication signaling is URLLC indication signaling indicating whether URLLC is supported, the state 4-1 is that the URLLC is not supported, and the state 4-2 is that the URLLC is supported.

Alternatively, the fourth indication signaling is indication signaling indicating whether MCS_U_X is supported, the state 4-2 is that MCS_U_X of URLLC is supported and the state 4-1 is a state other than the state 4-2, or the state 4-2 is that MCS_U_X is supported, is an absent state or a default state and the state 4-1 is a state other than the state 4-2.

### Example Nine

In a case where downlink data satisfies a first condition, selecting an MCS table to determine a modulation and coding scheme at least includes one of the cases described below.

(9.1) In a case where fifth indication signaling is in a state 5-1, in response to fifth MCS-1 table indication signaling being set to 256QAM, the MCS_8 table is selected to determine the modulation and coding scheme, and in response to the fifth MCS-1 table indication signaling being not set to 256QAM, an MCS_6_X table is selected to determine the modulation and coding scheme.

(9.3) In a case where fifth indication signaling is in a state 5-2, in response to fifth MCS-2 indication signaling being set to be in a state mcs-5-1, an MCS_6_X table is selected to determine the modulation and coding scheme; in a case where the fifth indication signaling is in a state 5-2, in response to fifth MCS-2 indication signaling being set to be in a state mcs-5-2, an MCS_U_x table is selected to determine the modulation and coding scheme.

### Example Ten

In a case where downlink data satisfies a second condition, selecting an MCS table to determine a modulation and coding scheme at least includes one of the cases described below:

(10.1) an MCS_6_X table is selected to determine the modulation and coding scheme; or

(10.2) in a case where fifth indication signaling is in a state 5-1, an MCS_6_X table is selected to determine the modulation and coding scheme; in a case where the fifth indication signaling is in a state 5-2, in response to fifth MCS-2 indication signaling being set to be in a state mcs-5-2, an MCS_U_X table is selected to determine the modulation and coding scheme.

The (10.1) indicates that the modulation and coding scheme is determined according to the MCS_6_X table as long as downlink data satisfies the second condition without considering states of the fifth indication signaling, fifth MCS-1 table and fifth MCS-2.

A mode for determining a downlink MCS table of (10.2) is shown in Table 10.1.

In the Table 10.1, in a case where data satisfies the second condition and in a case where fifth indication signaling is in a state 5-1, an MCS_6_X table is selected to determine the modulation and coding scheme.

In a case where fifth indication signaling is in a state 5-2, an MCS_U_X table is selected to determine the modulation and coding scheme.

TABLE 10.1

| | | |
|---|---|---|
| Fifth | State 5-1 | MCS_6_X |
| indication | | table |
| signaling | State 5-2 | MCS_U_X |
| | | table |

It is to be noted that the example nine and the example ten may be used in any combination to determine the modulation and coding scheme in a case where downlink data satisfies the first condition and the second condition.

It is to be noted that the fifth MCS-1 table indication signaling and the fifth MCS-2 indication signaling in the example nine and the example ten may be the same signaling or different signaling.

It is to be noted that the fifth indication signaling in the example nine and the example ten indicates the fifth MCS-1 table indication signaling or the fifth MCS-2 indication signaling, the state 5-1 is that the fifth MCS-1 table indication signaling is valid, or is an absent state or a default state, and the state 5-2 is that the fifth MCS-2 indication signaling is valid.

Alternatively, the fifth indication signaling indicates the fifth MCS-1 table indication signaling or the fifth MCS-2 indication signaling, the state 5-1 is that the fifth MCS-1 table indication signaling is valid, and the state 5-2 is that the fifth MCS-2 indication signaling is valid, or is an absent state or is a default state; it is to be noted that the fifth MCS-2 indication signaling in the example nine and the example ten indicates that the MCS_U_X table or the MCS_6_x table is valid, the state mcs-5-1 is that the MCS_6_X table indication signaling is valid, or is an absent state or is a default state and the state mcs-5-2 is that the MCS_U_X table indication signaling is valid.

Alternatively, the fifth MCS-2 indication signaling indicates that the MCS_U_X table or the MCS_6_X table is valid, the state mcs-5-1 is that the MCS_6_X table indication signaling is valid, and the state mcs-5-2 is that the MCS_U_X table indication signaling is valid, or is an absent state or is a default state.

Alternatively, the fifth MCS-2 indication signaling is BLER-target indication signaling, the state mcs-5-1 is 10⁻¹, an absent state or a default state and mcs-5-1 is 10⁻⁵, or the state mcs-5-1 is 10⁻¹ and mcs-5-1 is 10⁻⁵, an absent state or a default state.

It is to be noted that the fifth indication signaling in the example nine and the example ten is BLER-target indication signaling, the state 5-1 is 10⁻¹, an absent state or a default state and the state 5-2 is 10⁻⁵, or the state 5-1 is 10⁻¹ and the state 5-2 is 10⁻⁵, an absent state or a default state.

Alternatively, the state 5-1 of the fifth indication signaling is 10⁻¹, an absent state or a default state and the state 5-2 is 10⁻⁵, or the state 5-1 is 10⁻¹ and the state 5-2 is 10⁻⁵, an absent state or a default state.

Alternatively, the fifth indication signaling is URLLC indication signaling indicating whether URLLC is supported, the state 5-1 is that the URLLC is not supported, and the state 5-2 is that the URLLC is supported.

Alternatively, the fourth indication signaling is indication signaling indicating whether MCS_U_X is supported, the state 5-2 is that MCS_U_X of URLLC is supported and the state 5-1 is a state other than the state 5-2, or the state 5-2 is that MCS_U_X is supported, is an absent state or a default state and the state 5-1 is a state other than the state 5-2.

### Example Eleven

In a case where data satisfies a first condition, selecting an MCS table to determine a modulation and coding scheme at least includes one of the cases described below.

(11.1) In a case where sixth indication signaling is in a state 6-1, in response to sixth MCS table indication signaling being set to 256QAM, the MCS_8 table is selected to determine the modulation and coding scheme; in response to the sixth MCS table indication signaling being set to 64QAM, an MCS_6_X table is selected to determine the modulation and coding scheme; and in response to the sixth MCS table indication signaling being in another state, the MCS_6_X table is selected to determine the modulation and coding scheme.

(11.2) In a case where sixth indication signaling is in a state 6-2, in response to sixth MCS table indication signaling being set to 256QAM, the MCS_8 table is selected to determine the modulation and coding scheme; in response to the sixth MCS table indication signaling being set to 64QAM, an MCS_6_X table is selected to determine the modulation and coding scheme; and in response to the sixth MCS table indication signaling being in another state, an MCS_U_X table is selected to determine the modulation and coding scheme.

### Example Twelve

In a case where data satisfies a second condition, selecting an MCS table to determine a modulation and coding scheme at least includes cases described below.

(12.1) An MCS_6_X table is selected to determine the modulation and coding scheme.

(12.2) In a case where sixth indication signaling is in a state 6-1, an MCS_6_X table is selected to determine the modulation and coding scheme; in a case where the sixth indication signaling is in a state 6-2, an MCS_6_X table is selected to determine the modulation and coding scheme.

The (12.1) indicates that the modulation and coding scheme is determined according to the MCS_6_X table as long as data satisfies the second condition. In this case, states of the sixth indication signaling and sixth MCS table indication signaling do not need to be considered.

A mode for determining a downlink MCS table of (12.2) is shown in Table 12.1.

In the Table 12.1, in a case where data satisfies the second condition and in a case where sixth indication signaling is in a state 6-1, an MCS_6_X table is selected to determine the modulation and coding scheme; in a case where the sixth indication signaling is in a state 6-2, an MCS_U_X table is selected to determine the modulation and coding scheme.

TABLE 12.1

| | | |
|---|---|---|
| Sixth | State 6-1 | MCS_6_X |
| indication | | table |
| signaling | State 6-2 | MCS_U_X |
| | | table |

It is to be noted that the example eleven and the example twelve may be used in any combination to determine the modulation and coding scheme in a case where downlink data satisfies the first condition and the second condition.

It is to be noted that the sixth indication signaling is BLER-target indication signaling, the state 6-1 is 10⁻¹, an absent state or a default state and the state 6-2 is 10⁻⁵, or the state 6-1 is 10⁻¹ and the state 6-2 is 10⁻⁵, an absent state or a default state.

Alternatively, the sixth indication signaling is URLLC indication signaling indicating whether URLLC is supported, the state 6-1 is that the URLLC is not supported, and the state 6-2 is that the URLLC is supported.

Alternatively, the sixth indication signaling is indication signaling indicating whether MCS_U_X is supported, the state 6-2 is that MCS_U_X of URLLC is supported and the state 6-1 is a state other than the state 6-2, or the state 6-2 is that MCS_U_X is supported, is an absent state or a default state and the state 6-1 is a state other than the state 6-2.

### Example Thirteen

In a case where data satisfies a first condition, selecting an MCS table to determine a modulation and coding scheme at least includes one of the cases described below.

(13.1) In a case where seventh indication signaling is in a state 7-1, an MCS_6_X table is selected to determine the modulation and coding scheme.

(13.2) In a case where seventh indication signaling is in a state 7-2, an MCS_U_X table is selected to determine the modulation and coding scheme.

(13.3) In a case where seventh indication signaling is in a state 7-3, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, an MCS_U_X table is selected to determine the modulation and coding scheme.

(13.4) In a case where seventh indication signaling is in a state 7-3, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, the MCS_6_X table is selected to determine the modulation and coding scheme.

(13.5) In a case where seventh indication signaling is in a state 7-1, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, the MCS_6_x table is selected to determine the modulation and coding scheme.

(13.6) In a case where seventh indication signaling is in a state 7-2, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, an MCS_U_X table is selected to determine the modulation and coding scheme.

(13.7) In a case where seventh indication signaling is in a state 7-3, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, an MCS_U_X table is selected to determine the modulation and coding scheme.

(13.8) In a case where seventh indication signaling is in a state 7-3, in response to seventh MCS table indication signaling being set to 256QAM, the MCS_8 table is selected to determine the modulation and coding scheme; in response to the sixth MCS table indication signaling being set to 64QAM, an MCS_6_X table is selected to determine the modulation and coding scheme; and in response to the sixth MCS table indication signaling being in another state, the MCS_6_X table is selected to determine the modulation and coding scheme.

In a case where data satisfies the first condition, selecting an MCS table to determine a modulation and coding scheme can be achieved by any combination of (13.1) to (13.8). Table 13.1 to Table 13.4 are modes for determining a downlink MCS table in different states of the seventh indication signaling and the seventh MCS table indication signaling obtained through the above-mentioned combination mode.

For example, in the Table 13.1, in a case where data satisfies the first condition and in a case where seventh indication signaling is in a state 7-1, an MCS_6_X table is selected to determine the modulation and coding scheme; in a case where the seventh indication signaling is in a state 7-2, an MCS_U_X table is selected to determine the modulation and coding scheme; in a case where the seventh indication signaling is in a state 7-3, in response to seventh MCS table indication signaling being set to 256QAM, the MCS_8 table is selected to determine the modulation and coding scheme; in response to the seventh MCS table indication signaling being set to 64QAM, the MCS_6_X table is selected to determine the modulation and coding scheme; and in response to the seventh MCS table indication signaling being in another state, the MCS_U_X table is selected to determine the modulation and coding scheme.

For example, in Table 13.2, in a case where data satisfies the first condition and in a case where seventh indication signaling is in a state 7-1, an MCS_6_X table is selected to determine the modulation and coding scheme; in a case where the seventh indication signaling is in a state 7-2, an MCS_U_X table is selected to determine the modulation and coding scheme; in a case where the seventh indication signaling is in a state 7-3, in response to seventh MCS table indication signaling being set to 256QAM, the MCS_8 table is selected to determine the modulation and coding scheme; in response to the seventh MCS table indication signaling being set to 64QAM, the MCS_6_X table is selected to determine the modulation and coding scheme; and in response to the seventh MCS table indication signaling being in another state, the MCS_6_X table is selected to determine the modulation and coding scheme.

For example, in Table 13.3, in a case where data satisfies the first condition and in a case where seventh indication signaling is in a state 7-1, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, the MCS_6_X table is selected to determine the modulation and coding scheme.

In a case where seventh indication signaling is in a state 7-2, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, an MCS_U_X table is selected to determine the modulation and coding scheme.

In a case where seventh indication signaling is in a state 7-3, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, the MCS_6_X table is selected to determine the modulation and coding scheme.

For example, in the Table 13.4, in a case data satisfies the first condition and in a case where seventh indication signaling is in a state 7-1, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, the MCS_6_X table is selected to determine the modulation and coding scheme.

In a case where seventh indication signaling is in a state 7-2, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, an MCS_U_X table is selected to determine the modulation and coding scheme.

In a case where seventh indication signaling is in a state 7-3, in response to seventh MCS table indication signaling being set to 256QAM, the MCS_8 table is selected to determine the modulation and coding scheme; in response to the seventh MCS table indication signaling being set to 64QAM, an MCS_6_X table is selected to determine the modulation and coding scheme; and in response to the seventh MCS table indication signaling being in another state, an MCS_U_X table is selected to determine the modulation and coding scheme.

TABLE 13.1

| | | Seventh MCS table indication signaling | | |
|---|---|---|---|---|
| | | 256QAM | 64QAM | Others |
| Seventh | State 7-1 | MCS_6_X | MCS_6_X | MCS_6_X |
| indication | | table | table | table |
| signaling | State 7-2 | MCS_U_X | MCS_U_X | MCS_U_X |
| | | table | table | table |
| | State 7-3 | MCS_8 | MCS_6_X | MCS_6_X |
| | | table | table | table |

TABLE 13.2

| | | Seventh MCS table indication signaling | | |
|---|---|---|---|---|
| | | 256QAM | 64QAM | Others |
| Seventh | State 7-1 | MCS_6_X | MCS_6_X | MCS_6_X |
| indication | | table | table | table |
| signaling | State 7-2 | MCS_U_X | MCS_U_X | MCS_U_X |
| | | table | table | table |
| | State 7-3 | MCS_8 | MCS_6_X | MCS_U_X |
| | | table | table | table |

TABLE 13.3

| | | Seventh MCS table indication signaling | | |
|---|---|---|---|---|
| | | 256QAM | 64QAM | Others |
| Seventh | State 7-1 | MCS_8 | MCS_6_X | MCS_6_X |
| indication | | table | table | table |
| signaling | State 7-2 | MCS_8 | MCS_6_X | MCS_U_X |
| | | table | table | table |
| | State 7-3 | MCS_8 | MCS_6_X | MCS_U_X |
| | | table | table | table |

TABLE 13.4

| | | Seventh MCS table indication signaling | | |
|---|---|---|---|---|
| | | 256QAM | 64QAM | Others |
| Seventh | State 7-1 | MCS_8 | MCS_6_X | MCS_6_X |
| indication | | table | table | table |
| signaling | State 7-2 | MCS_8 | MCS_6_X | MCS_U_X |
| | | table | table | table |
| | State 7-3 | MCS_8 | MCS_6_X | MCS_6_X |
| | | table | table | table |

### Example Fourteen

In a case where data satisfies a second condition, selecting an MCS table to determine a modulation and coding scheme includes cases described below.

(14.1) An MCS_6_X table is selected to determine the modulation and coding scheme.

(14.2) In a case where seventh indication signaling is in a state 7-2, an MCS_U_X table is selected to determine the modulation and coding scheme.

(14.3) In a case where seventh indication signaling is not in a state 7-2, an MCS_6_X table is selected to determine the modulation and coding scheme.

The (14.1) indicates that the modulation and coding scheme is determined according to the MCS_6_X table as long as downlink data satisfies the second condition without considering states of the seventh indication signaling and seventh MCS table indication signaling.

A mode for determining an MCS table of (14.2) is shown in Table 14.1.

In Table 14.1, in a case where data satisfies the second condition and in a case where seventh indication signaling is in a state 7-1, an MCS_6_X table is selected to determine the modulation and coding scheme, and in a case where the second indication signaling is in a state 7-2, an MCS_U_X table is selected to determine the modulation and coding scheme.

TABLE 14.1

| | | |
|---|---|---|
| Seventh | State 7-1 | MCS_6_X |
| indication | | table |
| signaling | State 7-2 | MCS_U_X |
| | | table |

It is to be noted that the example thirteen and the example fourteen may be used in any combination to determine the modulation and coding scheme in a case where data satisfies the first condition and the second condition.

It is to be noted that the seventh indication signaling is BLER-target indication signaling, the state 7-1 is 10⁻¹, the state 7-2 is 10⁻⁵, and the state 7-3 is an absent state or a default state; or the state 7-1 of the seventh indication signaling is 10⁻¹, the state 7-2 is 10⁻⁵, and the state 7-3 is an absent state or a default state.

### Example Fifteen

A modulation and coding scheme is determined according to a modulation order and/or a lowest spectral efficiency that a CQI table can support.

In a case where data satisfies a first condition, determining a modulation and coding scheme according to a modulation order and/or a lowest spectral efficiency that a CQI table can support at least includes one of the cases described below.

(15.1) In a case where a lowest spectral efficiency in a CQI table to which a reported CQI index belongs is 78/1024*2, and a maximum modulation order is 6, a modulation order and a coding scheme are determined according to an MCS_6_X table.

(15.2) In a case where a maximum modulation order in a CQI table to which a reported CQI index belongs is 8, a modulation order and a coding scheme are determined according to an MCS_8 table.

(15.3) In a case where a lowest spectral efficiency in a CQI table to which a reported CQI index belongs is between 30/1024*2 and 50/1024*2, and a maximum modulation order is 6, a modulation order and a coding scheme are determined according to an MCS_U_X table.

### Example Sixteen

A modulation and coding scheme is determined according to a modulation order and/or a lowest spectral efficiency that a CQI table can support.

In a case where data satisfies a second condition, determining a modulation and coding scheme according to a modulation order and/or a lowest spectral efficiency that a CQI table can support at least includes one of the cases described below.

(16.1) A modulation order and a coding scheme are determined according to an MCS_6_X table.

(16.2) In a case where a lowest spectral efficiency in a CQI table to which a reported CQI index belongs is 78/1024*2, a modulation order and a coding scheme are determined according to an MCS_6_X table; in a case where the lowest spectral efficiency in the CQI table to which the reported CQI index belongs is between 30/1024*2 and 50/1024*2, the modulation order and the coding scheme are determined according to an MCS_U_X table.

It is to be noted that in the example one to the example sixteen, the MCS_6_x table is the MCS_6 or the MCS_6 BPSK, and the MCS_U_x table is the MCS_U or the MCS_U_BPSK.

It is to be noted that in a case where a link direction is downlink, in the example one to the example sixteen, the MCS_6_x table is the MCS_6, the MCS_U_x table is the MCS_U, and the first condition in the example one to the example fourteen includes at least one of the conditions described below.

The downlink control signaling format is DCI format 1_1, and the downlink control signaling carries the modulation and coding scheme field.

The CRC scrambling method corresponding to the downlink control signaling is scrambled by a C-RNTI, and the downlink control signaling carries the modulation and coding scheme field.

The CRC scrambling method corresponding to the downlink control signaling is scrambled by a CS-RNTI, and the downlink control signaling carries the modulation and coding scheme field.

For example, the first condition is that the downlink control signaling format is DCI format 1_1, the CRC scrambling method corresponding to the downlink control signaling is scrambled by a C-RNT, and the downlink control signaling carries the modulation and coding scheme field; or the first condition is that the downlink control signaling format is DCI format 1_1, the CRC scrambling method corresponding to the downlink control signaling is scrambled by a CS-RNTI, and the downlink control signaling carries the modulation and coding scheme field.

It is to be noted that in a case where a link direction is downlink, in the example one to the example sixteen, the MCS_6_x table is the MCS_6, the MCS_U_x table is the MCS_U, and the second condition in the example one to the example sixteen includes at least one of the conditions described below.

The downlink control signaling format is DCI format 1_0, and the downlink control signaling carries the modulation and coding scheme field.

The CRC scrambling method corresponding to the downlink control signaling is not scrambled by a C-RNTI and/or a CS-RNTI and/or a SP-CSI-RNTI, and the downlink control signaling carries the modulation and coding scheme field.

For example, the second condition is that the downlink control signaling format is DCI format 1_0; or the second condition is that the CRC scrambling method corresponding to the downlink control signaling is not scrambled by a C-RNTI or a CS-RNTI, and the downlink control signaling carries the modulation and coding scheme field.

It is to be noted that in a case where a link direction is uplink and in a case where transform precoding is disabled, in the example one to the example fourteen, the MCS_6_x table is the MCS_6, the MCS_U_x table is the MCS_U, and the first condition in the example one to the example sixteen includes at least one of the conditions described below.

The downlink control signaling format is DCI format 0_1, and the downlink control signaling carries the modulation and coding scheme field.

The CRC scrambling method corresponding to the downlink control signaling is not scrambled by a C-RNTI and/or a CS-RNTI and/or a SP-CSI-RNTI, and the downlink control signaling carries the modulation and coding scheme field.

For example, in a case where a link direction is uplink and in a case where transform precoding is disabled, the first condition is that the downlink control signaling format is DCI format 0_1, the CRC scrambling method corresponding to the downlink control signaling is scrambled by a C-RNTI, and the downlink control signaling carries the modulation and coding scheme field; or in a case where a link direction is uplink and in a case where the transform precoding is disabled, the first condition is that the downlink control signaling format is DCI format 0_1, the CRC scrambling method corresponding to the downlink control signaling is scrambled by the CS-RNTI, and the downlink control signaling carries the modulation and coding scheme field; or in a case where a link direction is uplink and in a case where the transform precoding is disabled, the first condition is that the downlink control signaling format is DCI format 0_1, the CRC scrambling method corresponding to the downlink control signaling is scrambled by a SP-CSI-RNTI, and the downlink control signaling carries the modulation and coding scheme field.

It is to be noted that in the case where a link direction is uplink and in a case where transform precoding is disabled, in the example one to the example sixteen, the MCS_6_x table is the MCS_6 the MCS_U_x table is the MCS_U and the second condition in the example one to the example sixteen includes at least one of the conditions described below.

The downlink control signaling format is DCI format 0_0, and the downlink control signaling carries the modulation and coding scheme field.

The CRC scrambling method corresponding to the downlink control signaling is not scrambled by a C-RNTI and/or a CS-RNTI and/or a SP-CSI-RNTI, and the downlink control signaling carries the modulation and coding scheme field.

For example, for uplink data, in a case where transform precoding is disabled, the second condition is that the downlink control signaling format is DCI format 0_0; or the CRC scrambling method corresponding to the downlink control signaling is not scrambled by a C-RNTI, a CS-RNTI and a SP-CSI-RNTI, and the downlink control signaling carries the modulation and coding scheme field.

It is to be noted that in a case where a link direction is uplink and in a case where transform precoding is enabled, in the example one to the example sixteen, the MCS_6_x table is the MCS_6 BPSK, the MCS_U_x table is the MCS_U_BPSK, and the first condition in the example one to the example sixteen includes at least one of the conditions described below.

The downlink control signaling format is DCI format 0_1, and the downlink control signaling carries the modulation and coding scheme field.

The CRC scrambling method corresponding to the downlink control signaling is not scrambled by a C-RNTI and/or a CS-RNTI and/or a SP-CSI-RNTI, and the downlink control signaling carries the modulation and coding scheme field.

For example, in the case where a link direction is uplink and in a case where transform precoding is enabled, the first condition is that the downlink control signaling format is DCI format 0_1, the CRC scrambling method corresponding to the downlink control signaling is scrambled by a C-RNTI, and the downlink control signaling carries the modulation and coding scheme field; or in a case where a link direction is uplink and in a case where the transform precoding is enabled, the first condition is that the downlink control signaling format is DCI format 0_1, the CRC scrambling method corresponding to the downlink control signaling is scrambled by a CS-RNTI, and the downlink control signaling carries the modulation and coding scheme field; or in a case where a link direction is uplink and in a case where the transform precoding is enabled, the first condition is that the downlink control signaling format is DCI format 0_1, the CRC scrambling method corresponding to the downlink control signaling is scrambled by a SP-CSI-RNTI, and the downlink control signaling carries the modulation and coding scheme field.

It is to be noted that in a case where a link direction is uplink and in a case where transform precoding is enabled, in the example one to the example sixteen, the MCS_6_x table is the MCS_6 BPSK, the MCS_U_x table is the MCS_U_BPSK, and the second condition in the example one to the example sixteen includes at least one of the conditions described below.

The downlink control signaling format is DCI format 0_0, and the downlink control signaling carries the modulation and coding scheme field.

The CRC scrambling method corresponding to the downlink control signaling is not scrambled by a C-RNTI and/or a CS-RNTI and/or a SP-CSI-RNTI, and the downlink control signaling carries the modulation and coding scheme field.

For example, in the case where a link direction is uplink and in a case where transform precoding is enabled, the second condition is that the downlink control signaling format is DCI format 0_0; or the CRC scrambling method corresponding to the downlink control signaling is not scrambled by a C-RNTI, a CS-RNTI and a SP-CSI-RNTI, and the downlink control signaling carries the modulation and coding scheme field.

It is to be noted that a radio network temporary identifier (RNTI) includes a cell RNTI (C-RNTI), a configured scheduling RNTI (CS-RNTI), an interruption RNTI (INT-RNTI), a slot format indication RNTI (SFI-RNTI), a semi-persistent CSI RNTI (SP-CSI-RNTI), a transmit power control-configured scheduling-RNTI (TPC-CS-RNTI), a transmit power control-sounding reference symbols-RNTI (TPC-SRS-RNTI) and so on. Usages of different RNTIs are shown in Table 5.

TABLE 5

| RNTI | Usage | Transport Channel | Logical Channel |
|---|---|---|---|
| P-RNTI | Paging and System Information | PCH | PCCH |
| | change notification | | |
| SI-RNTI | Broadcast of System Information | DL-SCH | BCCH, |
| | | | BR-BCCH |
| RA-RNTI | Random Access Response | DL-SCH | N/A |
| Temporary C-RNTI | Contention Resolution (when no | DL-SCH | CCCH |
| | valid C-RNTI is available) | | |
| Temporary C-RNTI | Msg3 transmission | UL-SCH | CCCH, DCCH, |
| | | | DTCH |
| C-RNTI | Dynamically scheduled unicast | UL-SCH | DCCH, DTCH |
| | transmission | | |
| C-RNTI | Dynamically scheduled unicast | DL-SCH | CCCH, DCCH, |
| | transmission | | DTCH |
| C-RNTI | Triggering of PDCCH ordered | N/A | N/A |
| | random access | | |
| CS-RNTI | Configured scheduled unicast | DL-SCH, | DCCH, DTCH |
| | transmission (activation, | UL-SCH | |
| | reactivation and retransmission) | | |
| CS-RNTI | Configured scheduled unicast | N/A | N/A |
| | transmission (deactivation) | | |
| TPC-CS-RNTI | Configured scheduling uplink | N/A | N/A |
| | power control | | |
| TPC-PUCCH-RNTI | PUCCH power control | N/A | N/A |
| TPC-PUSCH-RNTI | PUSCH power control | N/A | N/A |
| TPC-SRS-RNTI | SRS trigger and power control | N/A | N/A |
| INT-RNTI | Indication pre-emption in DL | N/A | N/A |
| SFI-RNTI | Slot Format Indication on the | N/A | N/A |
| | given cell | | |
| SP-CSI-RNTI | Activation of Semi-persistent | N/A | N/A |
| | CSI reporting on PUSCH | | |

### Example Seventeen

In an embodiment, for a downlink modulation and coding method, in a case where the downlink control signaling format includes at least format 1_0, where the downlink control signaling carries the modulation and coding scheme field, selecting an MCS table to determine a modulation and coding scheme (as shown in FIG. 2) further includes steps described below.

In S201, an MCS_6 table is selected to determine the modulation and coding scheme.

In S202, the MCS_6 table or an MCS_U table is selected according to a predetermined condition to determine the modulation and coding scheme.

In an embodiment, the predetermined condition relates to at least one of: a UE capability; a UE category; or higher-layer configuration signaling.

In an embodiment, the higher-layer configuration signaling at least includes BLER-target indication signaling.

In an embodiment, in the downlink, selecting an MCS table to determine a modulation and coding scheme at least includes one of the cases described below.

In a case where the downlink control signaling format includes at least format 1_0, where the downlink control signaling carries the modulation coding scheme field, an MCS_6 table is selected to determine the modulation and coding scheme.

It is to be noted that at this time, as long as the DCI format is 1_0, an MCS_6 is selected to determine the modulation and coding scheme. At this time, states of the higher-layer configuration signaling including MCS table indication signaling and BLER-target indication signaling do not need to be considered.

In a case where the downlink control signaling format includes at least format 1_0 and in a case where configuration signaling coni is in a state s-1, an MCS_6 table is selected to determine the modulation and coding scheme; in a case where the configuration signaling coni is in a state s-2, an MCS_U table is selected to determine the modulation and coding scheme.

In the case where the downlink control signaling format includes at least format 1_0 and in a case where the UE capability is UE capability i1, an MCS_6 table is selected to determine the modulation and coding scheme; in a case where the UE capability is UE capability j1, an MCS_U table is selected to determine the modulation and coding scheme.

Here, i1 includes at least 1, and j1 is a positive integer greater than or equal to 2.

For example, in a case where the downlink control signaling format includes at least format 1_0 and in a case where the UE capability is UE capability 1, an MCS_6 table is selected to determine the modulation and coding scheme; in a case where the UE capability is UE capability 2, an MCS_U table is selected to determine the modulation and coding scheme.

It is to be noted that the UE capability represents UE processing time.

In a case where the downlink control signaling format includes at least format 1_0 and in a case where the UE category is UE category i2, an MCS_6 table is selected to determine the modulation and coding scheme; in a case where the UE category is UE category j2, an MCS_U table is selected to determine the modulation and coding scheme.

Here, i1 includes at least 1, and j2 is a positive integer greater than or equal to 2.

In a case where the downlink control signaling format includes at least format 1_0 and in a case where configuration signaling coni is in a state s-1, an MCS_6 table is selected to determine the modulation and coding scheme; in a case where the configuration signaling coni is in a state s-2 and in a case where the UE capability is UE capability i1, an MCS_6 table is selected to determine the modulation and coding scheme; in a case where the UE capability is UE capability j1, an MCS_U table is selected to determine the modulation and coding scheme.

Here, i1 includes at least 1, and j1 is a positive integer greater than or equal to 2.

For example, in a case where the downlink control signaling format includes at least format 1_0 and in a case where configuration signaling coni is in a state s-1, an MCS_6 table is selected to determine the modulation and coding scheme; in a case where the configuration signaling coni is in a state s-2 and in a case where the UE capability is UE capability 1, an MCS_6 table is selected to determine the modulation and coding scheme; in a case where the UE capability is UE capability 2, an MCS_U table is selected to determine the modulation and coding scheme.

In a case where the downlink control signaling format includes at least format 1_0 and in a case where configuration signaling coni is in a state s-1, an MCS_6 table is selected to determine the modulation and coding scheme; in a case where the configuration signaling coni is in a state s-2 and in a case where the UE category is UE capability i2, an MCS_6 table is selected to determine the modulation and coding scheme; in a case where the UE capability is UE capability j2, an MCS_U table is selected to determine the modulation and coding scheme.

Here, i includes at least 1, and j2 is a positive integer greater than or equal to 2.

It is to be noted that the configuration signaling coni is BLER-target indication signaling, the state s-1 is 10⁻¹, an absent state or a default state and the state s-2 is 10⁻⁵, or the state s-1 is 10⁻¹ and the state s-2 is 10⁻⁵, an absent state or a default state.

Alternatively, the state 5-1 of the configuration signaling coni is 10⁻¹, an absent state or a default state and the state s-2 is 10⁻⁵, or the state s-1 is 10⁻¹ and the state s-2 is 10⁻⁵, an absent state or a default state.

Alternatively, the configuration signaling coni is URLLC indication signaling indicating whether URLLC is supported, the state 2-1 is that the URLLC is not supported, and the state 2-2 is that the URLLC is supported.

Alternatively, the configuration signaling coni is a configuration parameter indicating whether MCS_U is supported, the state s-2 is that MCS_U of URLLC is supported and the state s-1 is a state other than the state 1-2, or the state s-2 is that MCS_U is supported, is an absent state or a default state and the state s-1 is a state other than the state 1-2.

### Example Eighteen

In an embodiment, for an uplink modulation and coding method, in a case where the downlink control signaling format includes at least DCI format 0_0, where the downlink control signaling carries the modulation and coding scheme field, selecting an MCS table to determine a modulation and coding scheme further includes steps described below.

An MCS_6 table is selected to determine the modulation and coding scheme.

An MCS_6 table or an MCS_U table is selected according to a predetermined condition to determine the modulation and coding scheme.

In an embodiment, the predetermined condition relates to at least one of: a UE capability; a UE category; or higher-layer configuration signaling.

In an embodiment, optionally, transform precoding is disabled.

In an embodiment, the higher-layer configuration signaling at least includes BLER-target indication signaling.

In an embodiment, in the downlink, selecting an MCS table to determine a modulation and coding scheme at least includes one of the cases described below.

(1) In a case where the downlink control signaling format includes at least format 0_0, where the downlink control signaling carries the modulation and coding scheme field, an MCS_6 table is selected to determine the modulation and coding scheme.

It is to be noted that at this time, as long as the DCI format is 0_0, an MCS_6 table is selected to determine the modulation and coding scheme according to the (1). At this time, states of the higher-layer configuration signaling including MCS table indication signaling and BLER-target indication signaling do not need to be considered.

(2) In a case where the downlink control signaling format includes at least format 0_0 and in a case where configuration signaling coni is in a state s-1, an MCS_6 table is selected to determine the modulation and coding scheme; in a case where the configuration signaling coni is in a state s-2, an MCS_U table is selected to determine the modulation and coding scheme.

(3) In a case where the downlink control signaling format includes at least format 0_0 and in a case where the UE capability is UE capability i1, an MCS_6 table is selected to determine the modulation and coding scheme; in a case where the UE capability is UE capability j1, an MCS_U table is selected to determine the modulation and coding scheme.

Here, i1 includes at least 1, and j1 is a positive integer greater than or equal to 2.

For example, in a case where the downlink control signaling format includes at least format 0_0 and in a case where the UE capability is UE capability 1, an MCS_6 table is selected to determine the modulation and coding scheme; in a case where the UE capability is UE capability 2, an MCS_U table is selected to determine the modulation and coding scheme.

It is to be noted that the UE capability represents UE processing time.

(4) In a case where the downlink control signaling format includes at least format 0_0 and in a case where the UE category is UE category i2, an MCS_6 table is selected to determine the modulation and coding scheme; in a case where the UE category is UE category j2, an MCS_U table is selected to determine the modulation and coding scheme.

Here, i1 includes at least 1, and j1 is a positive integer greater than or equal to 2.

(5) In a case where the downlink control signaling format includes at least format 0_0 and in a case where configuration signaling coni is in a state s-1, an MCS_6 table is selected to determine the modulation and coding scheme; in a case where the configuration signaling coni is in a state s-2 and in a case where the UE capability is UE capability i1, an MCS_6 table is selected to determine the modulation and coding scheme; in a case where the UE capability is UE capability j1, an MCS_U table is selected to determine the modulation and coding scheme.

Here, i1 includes at least 1, and j1 is a positive integer greater than or equal to 2.

For example, in a case where the downlink control signaling format includes at least format 0_0 and in a case where configuration signaling coni is in a state s-1, an MCS_6 table is selected to determine the modulation and coding scheme; in a case where the configuration signaling coni is in a state s-2 and in a case where the UE capability is UE capability 1, an MCS_6 table is selected to determine the modulation and coding scheme; in a case where the UE capability is UE capability 2, an MCS_U table is selected to determine the modulation and coding scheme.

(6) In a case where the downlink control signaling format includes at least format 0_0 and in a case where configuration signaling coni is in a state s-1, an MCS_6 table is selected to determine the modulation and coding scheme; in a case where the configuration signaling coni is in a state s-2 and in a case where the UE category is UE capability i2, an MCS_6 table is selected to determine the modulation and coding scheme; in a case where the UE capability is UE capability j2, an MCS_U table is selected to determine the modulation and coding scheme.

Here, i includes at least 1, and j2 is a positive integer greater than or equal to 2.

It is to be noted that the configuration signaling coni is BLER-target indication signaling, the state s-1 is 10⁻¹, an absent state or a default state and the state s-2 is 10⁻⁵, or the state s-1 is 10⁻¹ and the state s-2 is 10⁻⁵, an absent state or a default state.

Alternatively, the state 5-1 of the configuration signaling coni is 10⁻¹, an absent state or a default state and the state s-2 is 10⁻⁵, or the state s-1 is 10⁻¹ and the state s-2 is 10⁻⁵, an absent state or a default state.

Alternatively, the configuration signaling coni is URLLC indication signaling indicating whether URLLC is supported, the state 2-1 is that the URLLC is not supported, and the state 2-2 is that the URLLC is supported.

Alternatively, the configuration signaling coni is a configuration parameter indicating whether MCS_U is supported, the state s-2 is that MCS_U of URLLC is supported and the state s-1 is a state other than the state 1-2, or the state s-2 is that MCS_U is supported, is an absent state or a default state and the state s-1 is a state other than the state 1-2.

### Example Nineteen

In an embodiment, for an uplink modulation and coding method, in a case where the downlink control signaling format includes at least DCI format 0_0, where the downlink control signaling carries the modulation and coding scheme field, selecting an MCS table to determine a modulation and coding scheme further includes steps described below.

An MCS_6 table is selected to determine the modulation and coding scheme.

An MCS_6 BPSK table or an MCS_U_BPSK table is selected according to a predetermined condition to determine the modulation and coding scheme.

In an embodiment, the predetermined condition relates to at least one of: a UE capability; a UE category; or higher-layer configuration signaling.

In an embodiment, transform precoding is enabled.

In an embodiment, the higher-layer configuration signaling at least includes BLER-target indication signaling.

In an embodiment, in the downlink, selecting an MCS table to determine a modulation and coding scheme at least includes one of the cases described below.

(1) In a case where the downlink control signaling format includes at least format 0_0, where the downlink control signaling carries the modulation and coding scheme field, an MCS_6 BPSK table is selected to determine the modulation and coding scheme.

It is to be noted that at this time, as long as the DCI format is 0_0, an MCS_6 BPSK table is selected to determine the modulation and coding scheme according to the (1). At this time, states of the higher-layer configuration signaling including MCS table indication signaling and BLER-target indication signaling do not need to be considered.

(2) In a case where the downlink control signaling format includes at least format 0_0 and in a case where configuration signaling coni is in a state s-1, an MCS_6 BPSK table is selected to determine the modulation and coding scheme; in a case where the configuration signaling coni is in a state s-2, an MCS_U_BPSK table is selected to determine the modulation and coding scheme.

(3) In a case where the downlink control signaling format includes at least format 0_0 and in a case where the UE capability is UE capability i1, an MCS_6 BPSK table is selected to determine the modulation and coding scheme; in a case where the UE capability is UE capability j1, an MCS_U_BPSK table is selected to determine the modulation and coding scheme.

Here, i1 includes at least 1, and j1 is a positive integer greater than or equal to 2.

For example, in a case where the downlink control signaling format includes at least format 0_0 and in a case where the UE capability is UE capability 1, an MCS_6 BPSK table is selected to determine the modulation and coding scheme; in a case where the UE capability is UE capability 2, an MCS_U_BPSK table is selected to determine the modulation and coding scheme.

It is to be noted that the UE capability represents UE processing time.

(4) In a case where the downlink control signaling format includes at least format 0_0 and in a case where the UE category is UE category i2, an MCS_6 BPSK table is selected to determine the modulation and coding scheme; in a case where the UE category is UE category j2, an MCS_U_BPSK table is selected to determine the modulation and coding scheme.

Here, i1 includes at least 1, and j2 is a positive integer greater than or equal to 2.

(5) In a case where the downlink control signaling format includes at least format 0_0 and in a case where configuration signaling coni is in a state s-1, an MCS_6 BPSK table is selected to determine the modulation and coding scheme; in a case where the configuration signaling coni is in a state s-2 and in a case where the UE capability is UE capability i1, an MCS_6 BPSK table is selected to determine the modulation and coding scheme; in a case where the UE capability is UE capability j1, an MCS_U_BPSK table is selected to determine the modulation and coding scheme.

Here, i1 includes at least 1, and j1 is a positive integer greater than or equal to 2.

For example, in a case where the downlink control signaling format includes at least format 0_0 and in a case where configuration signaling coni is in a state s-1, an MCS_6 BPSK table is selected to determine the modulation and coding scheme; in a case where configuration signaling coni is in a state s-2 and in a case where the UE capability is UE capability 1, an MCS_6 BPSK table is selected to determine the modulation and coding scheme; in a case where the UE capability is UE capability 2, an MCS_U_BPSK table is selected to determine the modulation and coding scheme.

(6) In a case where the downlink control signaling format includes at least format 0_0 and in a case where configuration signaling coni is in a state s-1, an MCS_6 BPSK table is selected to determine the modulation and coding scheme; in a case where the configuration signaling coni is in a state s-2 and in a case where the UE category is UE capability i2, an MCS_6 BPSK table is selected to determine the modulation and coding scheme; in a case where the UE capability is UE capability j2, an MCS_U_BPSK table is selected to determine the modulation and coding scheme.

Here, i includes at least 1, and j2 is a positive integer greater than or equal to 2.

It is to be noted that the configuration signaling coni is BLER-target indication signaling, the state s-1 is 10⁻¹, an absent state or a default state and the state s-2 is 10⁻⁵, or the state s-1 is 10⁻¹ and the state s-2 is 10⁻⁵, an absent state or a default state.

Alternatively, the state s-1 of the configuration signaling coni is 10⁻¹, an absent state or a default state and the state s-2 is 10⁻⁵, or the state s-1 is 10⁻¹ and the state s-2 is 10⁻⁵, an absent state or a default state.

Alternatively, the configuration signaling coni is URLLC indication signaling indicating whether URLLC is supported, the state 2-1 is that the URLLC is not supported, and the state 2-2 is that the URLLC is supported.

Alternatively, the configuration signaling coni is a configuration parameter indicating whether MCS_U is supported, the state s-2 is that MCS_U of URLLC is supported and the state s-1 is a state other than the state 1-2, or the state s-2 is that MCS_U is supported, is an absent state or a default state and the state s-1 is a state other than the state 1-2.

### Embodiment Two

A CQI reporting method provided by an embodiment includes steps described below.

A CQI index is selected and transmission is performed on an uplink channel.

The CQI index satisfies that a transport block is modulated and coded according to a modulation and coding scheme indicated by the CQI index in a CQI table and then transmitted on a downlink channel, and a block error rate of the transport block does not exceed a preset value.

The CQI table is selected from a CQI table set according to a predefined mode.

In an embodiment, the CQI table set at least includes one of: a CQI_6 table supporting a maximum modulation order of 6, a minimum spectral efficiency of 78/1024*2 and a maximum spectral efficiency of 948/1024*6; a CQI_8 table supporting a maximum modulation order of 8, a minimum spectral efficiency of 78/1024*2 and a maximum spectral efficiency of 948/1024*8; or a CQI_U table supporting a maximum modulation order of 6, a minimum spectral efficiency greater than or equal to 30/1024*2 and less than or equal to 50/1024*2 and a maximum spectral efficiency not greater than 772/1024*6.

Optionally, in an embodiment, the CQI_6 table may be as shown in Table 6.

Optionally, in an embodiment, the CQI_8 table may be as shown in Table 7.

It should be understood that Table 6 and Table 7 show only one example of the CQI_6 table and one example of the CQI_8 table in the embodiment, respectively, and the CQI_6 table and the CQI_8 table are not limited to those shown in Tables 6 and 7.

TABLE 6

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 7

| CQI index | modulation | code rate × 1024 | efficiency |
|---|---|---|---|
| 0 | out of range | | |
| 1 | QPSK | 78 | 0.1523 |
| 2 | QPSK | 193 | 0.3770 |
| 3 | QPSK | 449 | 0.8770 |
| 4 | 16QAM | 378 | 1.4766 |
| 5 | 16QAM | 490 | 1.9141 |
| 6 | 16QAM | 616 | 2.4063 |
| 7 | 64QAM | 466 | 2.7305 |
| 8 | 64QAM | 567 | 3.3223 |
| 9 | 64QAM | 666 | 3.9023 |
| 10 | 64QAM | 772 | 4.5234 |
| 11 | 64QAM | 873 | 5.1152 |
| 12 | 256QAM | 711 | 5.5547 |
| 13 | 256QAM | 797 | 6.2266 |
| 14 | 256QAM | 885 | 6.9141 |
| 15 | 256QAM | 948 | 7.4063 |

In an embodiment, the predefined mode of the CQI reporting method relates to at least one of: higher-layer configuration signaling; a predefined subcarrier spacing set; a predefined time domain resource mapping method; a predefined frequency domain resource set; a predefined antenna port set; or a predefined set of numbers of transmission layers.

### Example Twenty

Selecting a CQI table from the CQI table set includes cases described below.

In a case where eighth indication signaling is in a state 8-1, a CQI_6 table is selected.

In a case where eighth indication signaling is in a state 8-2, an MCS_U table is selected.

In a case where eighth indication signaling is in a state 8-3, in response to first CQI table indication signaling being set to 256QAM, a CQI_8 table is selected, and in response to the first CQI table indication signaling being not set to 256QAM, a CQI_U is selected.

In the example, the eighth indication signaling is BLER-target indication signaling, the state 8-1 is 10⁻¹, the state 8-2 is 10⁻⁵, and the state 8-3 is an absent state or a default state.

### Example Twenty-One

In a case where ninth indication signaling is in a state 9-1, in response to second CQI table indication signaling being set to 256QAM, a CQI_8 table is selected, and in response to the second CQI table indication signaling being not set to 256QAM, a CQI_6 table is selected.

In a case where the ninth indication signaling is in a state 9-1, a CQI_6 table is selected.

In a case where the ninth indication signaling is in a state 9-2, in response to second CQI table indication signaling being set to 256QAM, a CQI_8 table is selected, and in response to the second CQI table indication signaling being not set to 256QAM, a CQI_U table is selected.

In a case where the ninth indication signaling is in a state 9-2, a CQI_U table is selected.

In the example, the ninth indication signaling may be BLER-target indication signaling, the state 9-1 is 10⁻¹ and the state 9-2 is 10⁻⁵.

### Example Twenty-Two

In the example, the higher-layer configuration signaling includes tenth indication signaling and third CQI table indication signaling; and selecting a CQI table from the CQI table set according to the predefined mode at least includes one of the cases described below.

In a case where the tenth indication signaling is in a state 10-1, a CQI_6 table is selected.

In a case where the tenth indication signaling is in a state 10-2, a CQI_U table is selected.

In response to the third CQI table indication signaling being set to 256QAM, a CQI_8 table is selected.

In response to the third CQI table indication signaling being not set to 256QAM, a CQI_6 table is selected.

In the example, the tenth indication signaling is BLER-target indication signaling, the state 10-1 is 10⁻¹ and the state 10-2 is 10⁻⁵.

In the example, in response to the eighth indication signaling and the third CQI table indication signaling being simultaneously acquired, the CQI table is determined by one, which has a higher priority, of the eighth indication signaling or the third CQI table indication signaling.

Or in other examples, it is set that the eighth indication signaling and the third CQI table indication signaling cannot be configured simultaneously.

### Example Twenty-Three

In the example, the higher-layer configuration signaling includes eleventh indication signaling; and selecting a CQI table from the CQI table set according to the predefined mode at least includes one of the cases described below.

In response to the eleventh indication signaling being set to 256QAM, a CQI_8 table is selected.

In response to the eleventh indication signaling being set to 64QAM, a CQI_6 table is selected.

In a case where the eleventh indication signaling is in another state, a CQI_U table is selected.

In the example, the eleventh indication signaling is to indicate a state of the CQI_U table, or is an absent state or a default state or a state other than 256QAM and 64QAM.

### Example Twenty-Four

In the example, the higher-layer configuration signaling includes twelfth indication signaling and fourth CQI table indication signaling; and selecting a CQI table from the CQI table set according to the predefined mode at least includes one of the cases described below.

In a case where the twelfth indication signaling is in a state 12-1, in response to the fourth CQI table indication signaling being set to 256QAM, a CQI_8 table is selected; in response to the fourth CQI table indication signaling being set to 64QAM, a CQI_6 table is selected; and in response to the fourth CQI table indication signaling being set to be in another state, a CQI_U table is selected.

In a case where the twelfth indication signaling is in a state 12-2, in response to the fourth CQI table indication signaling being set to 256QAM, a CQI_8 table is selected; in response to the fourth CQI table indication signaling being set to 64QAM, a CQI_6 table is selected; and in response to the fourth CQI table indication signaling being set to be in another state, a CQI_U table is selected.

In the example, the twelfth indication signaling is BLER-target indication signaling, the state 12-1 is 10⁻¹, an absent state or a default state and the state 12-2 is 10⁻⁵, or the state 12-1 is 10⁻¹ and the state 12-2 is 10⁻⁵, an absent state or a default state.

Alternatively, the twelfth indication signaling is URLLC indication signaling indicating whether URLLC is supported, the state 12-1 is that the URLLC is not supported, and the state 12-2 is that the URLLC is supported.

Alternatively, the twelfth indication signaling is a configuration parameter indicating whether CQI_U is supported, the state 12-2 is that the CQI_U of the URLLC is supported and the state 12-1 is a state other than the state 12-2, or the state 12-2 is that the CQI_U is supported, is an absent state or a default state and the state 12-1 is a state other than the state 12-2.

### Example Twenty-Five

Selecting a CQI table from the CQI table set according to the predefined mode includes according to at least one of: a UE capability; a UE category; or higher-layer configuration signaling.

In an embodiment, the higher-layer configuration signaling at least includes BLER-target indication signaling.

In an embodiment, optionally, a case where the downlink control signaling format is DCI format 1_0 may be further included.

It is to be noted that in an embodiment, downlink control signaling format DCI format 1_0 carries a modulation and coding scheme field, where the modulation and coding scheme is obtained referring to a reported CQI.

In an embodiment, selecting a CQI table from the CQI table set according to the predefined mode at least includes one of the cases described below.

(1) A CQI is reported according to a CQI_6 table.

It is to be noted that states of the higher-layer configuration signaling including CQI table indication signaling and BLER-target indication signaling do not need to be considered.

(2) In a case where configuration signaling coni is in a state s-1, a CQI is reported according to a CQI_6 table; in a case where the configuration signaling coni is in a state s-2, the CQI is reported according to a CQI_U table.

(3) In a case where the UE capability is UE capability i1, a CQI is reported according to a CQI_6 table; in a case where the UE capability is UE capability j1, the CQI is reported according to a CQI_U table.

Here, i1 includes at least 1, and j1 is a positive integer greater than or equal to 2.

For example, in a case where the UE capability is UE capability 1, a CQI is reported according to a CQI_6 table; in a case where the UE capability is UE capability 2, the CQI is reported according to a CQI_U table.

It is to be noted that the UE capability represents UE processing time.

(4) In a case where the UE category is UE category i2, a CQI is reported according to a CQI_6 table; in a case where the UE category is UE category j2, the CQI is reported according to a CQI_U table.

i1 includes at least 1, and j2 is a positive integer greater than or equal to 2.

(5) In a case where configuration signaling coni is in a state s-1, a CQI is reported according to a CQI_6 table; in a case where the configuration signaling coni is in a state s-2 and in a case where the UE capability is UE capability i1, the CQI is reported according to the CQI_6 table; in a case where the UE capability is UE capability j1, the CQI is reported according to a CQI_U table.

Here, i1 includes at least 1, and j1 is a positive integer greater than or equal to 2.

For example, in a case where configuration signaling coni is in a state s-1, a CQI is reported according to a CQI_6 table; in a case where the configuration signaling coni is in a state s-2 and in a case where the UE capability is UE capability 1, the CQI is reported according to the CQI_6 table; in a case where the UE capability is UE capability 2, the CQI is reported according to a CQI_U table.

(6) In a case where configuration signaling coni is in a state s-1, a CQI is reported according to a CQI_6 table; in a case where the configuration signaling coni is in a state s-2 and in a case where the UE capability is UE capability i2, the CQI is reported according to the CQI_6 table; in a case where the UE capability is UE capability j2, the CQI is reported according to a CQI_U table.

Here, i includes at least 1, and j2 is a positive integer greater than or equal to 2.

It is to be noted that the configuration signaling coni is BLER-target indication signaling, the state s-1 is 10⁻¹, an absent state or a default state and the state s-2 is 10⁻⁵, or the state s-1 is 10⁻¹ and the state s-2 is 10⁻⁵, an absent state or a default state.

Alternatively, the state s-1 of the configuration signaling coni is 10⁻¹, an absent state or a default state and the state s-2 is 10⁻⁵, or the state s-1 is 10⁻¹ and the state s-2 is 10⁻⁵, an absent state or a default state.

Alternatively, the configuration signaling coni is URLLC indication signaling indicating whether URLLC is supported, the state 2-1 is that the URLLC is not supported, and the state 2-2 is that the URLLC is supported.

Alternatively, the configuration signaling coni is a configuration parameter indicating whether CQI_U is supported, the state s-2 is that MCS_U of URLLC is supported and the state s-1 is a state other than the state 1-2, or the state s-2 is that CQI_U is supported, is an absent state or a default state and the state s-1 is a state other than the state 1-2.

In the embodiment one or the embodiment two, the indication signaling coni or the indication signaling one to the indication signaling twelve may be BLER-target indication signaling among the higher-layer configuration signaling.

In the embodiment one or the embodiment two, the CQI table indication signaling may be cqi-Table among the higher-layer configuration signaling.

In the embodiment one or the embodiment two, in a case where a link direction is downlink, the MCS table indication signaling may be mcs-Table or mcs-Table-PDSCH.

In the embodiment one or the embodiment two, in a case where a link direction is uplink and in a case where transform precoding is disabled, the MCS table indication signaling may be mcs-Table or mcs-Table-PUSCH.

In the embodiment one or the embodiment two, in a case where a link direction is uplink and in a case where transform precoding is enabled, the MCS table indication signaling may be mcs-TableTransformPrecoder.

### Embodiment Three

The embodiment provides a modulation and coding apparatus which may be disposed on corresponding communications devices including but not limited to a terminal and a base station. Referring to FIG. 3, the modulation and coding apparatus includes a first information acquisition module 301 and a first processing module 302.

The first information acquisition module 301 is configured to select an MCS table from an MCS table set according to a predefined rule. Specific selecting modes are shown in the above-mentioned embodiments and will not be repeated here.

The first processing module 302 is configured to determine a modulation order and a target code rate according to the selected MCS table and a modulation and coding scheme field in downlink control signaling.

It should be understood that the above-mentioned functions of the first information acquisition module 301 and the first processing module 302 in the embodiment can be achieved by processors of the corresponding communications devices.

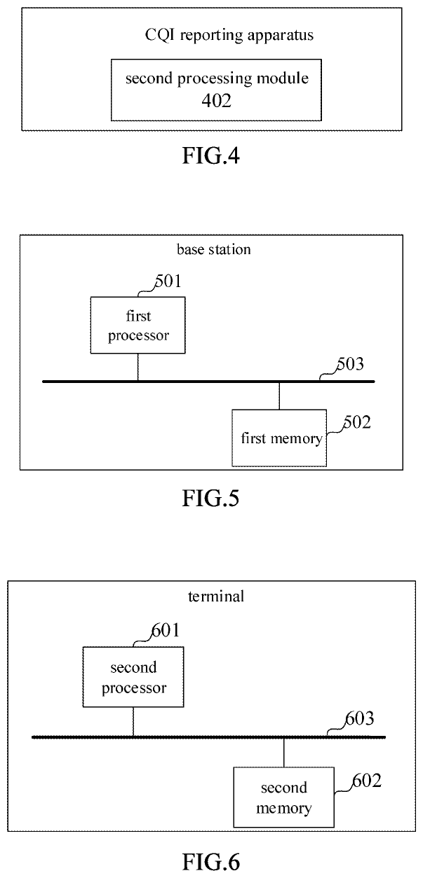

The embodiment further provides a CQI reporting apparatus which may be disposed on corresponding communications devices including but not limited to a terminal and a base station. Referring to FIG. 4, the CQI reporting apparatus includes a second processing module 402.

The second processing module 402 is configured to select a CQI index and perform transmission on an uplink channel; and the CQI index satisfies that a transport block is modulated and coded according to a modulation and coding scheme indicated by the CQI index in a CQI table and then transmitted on a downlink channel, and a block error rate of the transport block does not exceed a preset value.

The CQI table is selected from a CQI table set according to a predefined mode, and specific selecting processes are shown in the above-mentioned embodiments and will not be repeated here.

It should be understood that the above-mentioned functions of the second processing module 402 can be achieved by processors of the corresponding communications devices.

The embodiment further provides a base station, as shown in FIG. 5, including a first processor 501, a first memory 502 and a first communications bus 503.

The first communications bus 503 is configured to implement communication connection between the first processor 501 and the first memory 502.

The first processor 501 is configured to execute one or more first programs stored in the first memory 502, so as to implement steps of the modulation and coding method described in the above-mentioned embodiments.

Alternatively, the first processor 501 is configured to execute one or more third programs stored in the first memory 502, so as to implement steps of the CQI reporting method described in the above-mentioned embodiments.

The embodiment further provides a terminal, as shown in FIG. 6, including a second processor 601, a second memory 602 and a second communications bus 603.

The second communications bus 603 is configured to implement communication connection between the second processor 601 and the second memory 602.

The second processor 601 is configured to execute one or more second programs stored in the second memory 602, so as to implement steps of the modulation and coding method described in the above-mentioned embodiments.

Alternatively, the second processor 601 is configured to execute one or more third programs stored in the second memory 602, so as to implement steps of the CQI reporting method described in the above-mentioned embodiments.

The embodiment further provides a computer-readable storage medium which may be disposed on corresponding communications devices (including but not limited to a terminal and a base station), and which is configured to store one or more first programs. The one or more first programs may be executed by one or more processors to implement steps of the modulation and coding method described in the above embodiments.

Alternatively, the computer-readable storage medium stores one or more third programs executable by one or more processors, so as to implement steps of the CQI reporting method described in the above embodiments.

To facilitate understanding, a specifically designed MCS_U table and MCS_U_BPSK is described as an example in the embodiment. The MCS_U table may be used as a downlink MCS_U table and/or an uplink MCS_U table, and one design example is described below.

1.1 The lowest three spectral efficiencies (SEs) of MCS_U and MCS_U_BPSK are SE1, SE2 and SE3, where 30/1024×2≤SE1≤40/1024×2, 50/1024×2≤SE3≤60/1024×2, SE2=(SE1+SE3)/2+δ2 and −4/1024≤δ2≤4/1024.

1.2 The combination of the modulation scheme and the code rate included in the MCS_U table is a subset of Table 1.1, where 30/1024*2≤SE1≤40/1024*2, 50/1024*2≤SE3≤60/1024*2, SE2=(SE1+SE3)/2+82, SE4=(SE3+78/1024*2)/2+δ4, −4/1024≤δ2≤4/1024 and −4/1024≤δ4≤4/1024.

78/1024*2<SE5<120/1024*2.

120/1024*2<SE6<193/1024*2.

193/1024*2<SE7<308/1024*2.

308/1024*2<SE8<449/1024*2.

449/1024*2<SE9<602/1024*2.

602/1024*2<SE10<340/1024*4.

An exemplary MCS table is shown in Table 15.1 below.

TABLE 15.1

| | Modulation | Target code Rate | Spectral |
|---|---|---|---|
| Index | Order Qm | R × [1024] | efficiency |
| 0 | 2 | R1 | SE1 |
| 1 | 2 | R2 | SE2 |
| 2 | 2 | R3 | SE3 |
| 3 | 2 | R4 | SE4 |
| 4 | 2 | 78 | 0.15234375 |
| 5 | 2 | R5 | SE5 |
| 6 | 2 | 120 | 0.2344 |
| 7 | 2 | R6 | SE6 |
| 8 | 2 | 193 | 0.377 |
| 9 | 2 | R7 | SE7 |
| 10 | 2 | 308 | 0.6016 |
| 11 | 2 | R8 | SE8 |
| 12 | 2 | 449 | 0.877 |
| 13 | 2 | R9 | SE9 |
| 14 | 2 | 602 | 1.1758 |
| 15 | 2 | R10 | SE10 |
| 16 | 4 | 340 | 1.3281 |
| 17 | 4 | 378 | 1.4766 |
| 18 | 4 | 434 | 1.6953 |
| 19 | 4 | 490 | 1.9141 |
| 20 | 4 | 553 | 2.1602 |
| 21 | 4 | 616 | 2.4063 |
| 22 | 4 | 658 | 2.5703 |
| 23 | 6 | 438 | 2.5664 |
| 24 | 6 | 466 | 2.7305 |
| 25 | 6 | 517 | 3.0293 |
| 26 | 6 | 567 | 3.3223 |
| 27 | 6 | 616 | 3.6094 |
| 28 | 6 | 666 | 3.9023 |
| 29 | 6 | 719 | 4.2129 |
| 30 | 6 | 772 | 4.5234 |

| | | |
|---|---|---|
| 31 | 2 | reserved |
| 32 | 4 | reserved |
| 33 | 6 | reserved |

1.2.1 In one example, in Table 15.1, SE5=99×2/1024, SE6=157×2/1024, SE7=251×2/1024, SE8=379×2/1024, SE9=526×2/1024, SE10=679×2/1024.

1.2.2 In one example, the combination of the modulation scheme and the code rate included in the MCS_U table is the combination of the modulation scheme and the code rate except for those corresponding to index 29 and index 30 in the Table 15.1.

1.2.3 In one example, the combination of the modulation scheme and the code rate included in the MCS_U table is the combination of the modulation mode and the code rate except for those corresponding to index 27 and index 29 in the Table 15.1.

1.2.4 In one example, the combination of the modulation scheme and the code rate included in the MCS_U table is the combination of the modulation scheme and the code rate except for those corresponding to index 16 and index 23 in the Table 15.1.

Another exemplary MCS table is shown in Table 15.2 below.

2.1 An MCS_U_BPSK table includes n BPSK modulations, where 4≤n≤7.

2.2 The combination of the modulation scheme and the code rate included in the MCS_U_BPSK table is a subset of the Table 15.2, where 30/1024*2≤SE1≤40/1024*2, 50/1024*2≤SE3≤60/1024*2, SE2=(SE1+SE3)/2+δ2,

SE4=(SE3+78/1024*2)/2+δ4, −4/1024≤δ2≤4/1024, −4/1024≤δ4≤4/1024,

78/1024*2<SE5<120/1024*2, 120/1024*2<SE6<193/1024*2,

193/1024*2<SE7<308/1024*2, 308/1024*2<SE8<449/1024*2,

449/1024*2<SE9<602/1024*2, 602/1024*2<SE10<340/1024*4, and the value range of Qm1, Qm2, Qm3, Qm4, Qm45, Qm5 and Qm56 is {1, 2}.

TABLE 15.2

| | Modulation | Target code Rate | Spectral |
|---|---|---|---|
| Index | Order Qm | R × [1024] | efficiency |
| 0 | Qm1 | R1 | SE1 |
| 1 | Qm2 | R2 | SE2 |
| 2 | Qm3 | R3 | SE3 |
| 3 | Qm4 | R4 | SE4 |
| 4 | Qm45 | 78 | 0.15234375 |
| 5 | Qm5 | R5 | SE5 |
| 6 | Qm56 | 120 | 0.2344 |
| 7 | 2 | R6 | SE6 |
| 8 | 2 | 193 | 0.377 |
| 9 | 2 | R7 | SE7 |
| 10 | 2 | 308 | 0.6016 |
| 11 | 2 | R8 | SE8 |
| 12 | 2 | 449 | 0.877 |
| 13 | 2 | R9 | SE9 |
| 14 | 2 | 602 | 1.1758 |
| 15 | 2 | R10 | SE10 |
| 16 | 4 | 340 | 1.3281 |
| 17 | 4 | 378 | 1.4766 |
| 18 | 4 | 434 | 1.6953 |
| 19 | 4 | 490 | 1.9141 |
| 20 | 4 | 553 | 2.1602 |
| 21 | 4 | 616 | 2.4063 |
| 22 | 4 | 658 | 2.5703 |
| 23 | 6 | 438 | 2.5664 |
| 24 | 6 | 466 | 2.7305 |
| 25 | 6 | 517 | 3.0293 |
| 26 | 6 | 567 | 3.3223 |
| 27 | 6 | 616 | 3.6094 |
| 28 | 6 | 666 | 3.9023 |
| 29 | 6 | 719 | 4.2129 |
| 30 | 6 | 772 | 4.5234 |

| | | |
|---|---|---|
| 31 | 2 | reserved |
| 32 | 4 | reserved |
| 33 | 6 | reserved |

2.2.1 In one example, in the Table 15.2, SE5=99×2/1024, SE6=157×2/1024, SE7=251×2/1024, SE8=379×2/1024, SE9=526×2/1024, SE10=679×2/1024.

2.2.2 In one example, the combination of the modulation scheme and the code rate included in the MCS_U table is the combination of the modulation scheme and the code rate except for those corresponding to index 29 and index 30 in the Table 15.2.

2.2.3 In one example, the combination of the modulation scheme and the code rate included in the MCS_U table is the combination of the modulation scheme and the code rate except for those corresponding to index and index 29 in the Table 15.2.

2.2.4 In one example, the combination of the modulation scheme and the code rate included in the MCS_U table is the combination of the modulation scheme and the code rate except for those corresponding to index 16 and index 23 in the Table 15.2.

In one example, the CQI_U table may be as shown in Table 15.3 or Table 15.4.

TABLE 15.3

| CQI index | modulation | code rate × 1024 | efficiency |
|---|---|---|---|
| 0 | out of range | | |
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |
| 15 | 64QAM | 772 | 4.5234 |

TABLE 15.4

| CQI index | modulation | code rate × 1024 | efficiency |
|---|---|---|---|
| 0 | out of range | | |
| 1 | QPSK | 30 | 0.0586 |
| 2 | QPSK | 50 | 0.0977 |
| 3 | QPSK | 78 | 0.1523 |
| 4 | QPSK | 120 | 0.2344 |
| 5 | QPSK | 193 | 0.3770 |
| 6 | QPSK | 308 | 0.6016 |
| 7 | QPSK | 449 | 0.8770 |
| 8 | QPSK | 602 | 1.1758 |
| 9 | 16QAM | 378 | 1.4766 |
| 10 | 16QAM | 490 | 1.9141 |
| 11 | 16QAM | 616 | 2.4063 |
| 12 | 64QAM | 466 | 2.7305 |
| 13 | 64QAM | 567 | 3.3223 |
| 14 | 64QAM | 666 | 3.9023 |

| | | |
|---|---|---|
| 15 | 64QAM | reserved |

In one example, the MCS_U table may be as shown in Table 15.5.

TABLE 15.5

| MCS | Modulation | | |
|---|---|---|---|
| Index I_{MCS} | Order Qₘ | code rate × 1024 | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 340 | 1.3281 |
| 17 | 4 | 378 | 1.4766 |
| 18 | 4 | 434 | 1.6953 |
| 19 | 4 | 490 | 1.9141 |
| 20 | 4 | 553 | 2.1602 |
| 21 | 4 | 616 | 2.4063 |
| 22 | 4 | 658 | 2.5703 |
| 23 | 6 | 438 | 2.5664 |
| 24 | 6 | 466 | 2.7305 |
| 25 | 6 | 517 | 3.0293 |
| 26 | 6 | 567 | 3.3223 |
| 27 | 6 | 616 | 3.6094 |
| 28 | 6 | 666 | 3.9023 |

| | | |
|---|---|---|
| 29 | 2 | reserved |

| | |
|---|---|
| 30 | 4 |
| 31 | 6 |

In one example, the MCS_U_BPSK table may be as shown in Table 15.6.

TABLE 15.6

| MCS | Modulation | | |
|---|---|---|---|
| Index I_{MCS} | Order Qₘ | code rate × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 340 | 1.3281 |
| 17 | 4 | 378 | 1.4766 |
| 18 | 4 | 434 | 1.6953 |
| 19 | 4 | 490 | 1.9141 |
| 20 | 4 | 553 | 2.1602 |
| 21 | 4 | 616 | 2.4063 |
| 22 | 4 | 658 | 2.5703 |
| 23 | 6 | 466 | 2.7305 |
| 24 | 6 | 517 | 3.0293 |
| 25 | 6 | 567 | 3.3223 |
| 26 | 6 | 616 | 3.6094 |
| 27 | 6 | 666 | 3.9023 |

| | | |
|---|---|---|
| 28 | q | reserved |

| | |
|---|---|
| 29 | 2 |
| 30 | 4 |
| 31 | 6 |

In one example of the embodiment, for other services, a UE may consider that PT-RS does not exist when at least one of the conditions described below is satisfied.

In a case where an MCS_6 table is adopted, an MCS index for indication is less than 10.

In a case where an MCS_8 table is adopted, an MCS index for indication is less than 5.

In a case where an MCS_U table is adopted, an MCS index for indication is less than I_MCS, where 14≤I_MCS≤18.

Apparently, it should be understood by those skilled in the art that each of the above-mentioned modules or steps in the embodiments of the present disclosure may be implemented by a general-purpose computing apparatus, the modules or steps may be concentrated on a single computing apparatus or distributed on a network composed of multiple computing apparatuses, and alternatively, the modules or steps may be implemented by program codes executable by the computing apparatuses, so that the modules or steps may be stored in a computer storage medium (such as a read-only memory (ROM)/random access memory (RAM), a magnetic disk or an optical disk) and executed by the computing apparatuses. In some circumstances, the illustrated or described steps may be executed in sequences different from those described herein, or the modules or steps are made into various integrated circuit modules separately, or multiple modules or steps therein are made into a single integrated circuit module for implementation. Therefore, the present disclosure is not limited to any specific combination of hardware and software.

The preceding content is a more detailed description of embodiments of the present disclosure in conjunction with exemplary implementations. The description is not intended to limit embodiments of the present disclosure. For those skilled in the art to which the present disclosure pertains, a number of simple deductions or substitutions not departing from the concept of the present disclosure may be made and should fall within the scope of the present disclosure.

### INDUSTRIAL APPLICABILITY

In embodiments of the present disclosure, an MCS table supporting a minimum spectral efficiency less than 120/1024*2 is added in an MCS table set, and a selecting rule of an MCS table is provided. Therefore, compared with an MCS table set in the related protocols, communications requirements of higher reliability, higher coverage and lower transmission rate can be satisfied. Moreover, the embodiments of the present disclosure further provide a CQI reporting method and apparatus, a device and a storage medium to accurately satisfy current communications requirements, especially the communications requirements of higher reliability, higher coverage and lower transmission rate.

1. A modulation and coding method, comprising:
selecting a modulation and coding scheme (MCS) table from an MCS table set according to a predefined rule; and
determining a modulation order and a target code rate according to the selected MCS table and a modulation and coding scheme field in downlink control signaling;
wherein the MCS table set comprises an MCS table supporting a minimum spectral efficiency less than 120/1024*2.

2. The modulation and coding method according to claim 1, wherein the MCS table set at least comprises following three MCS tables:
an MCS_6 table supporting a maximum modulation order of 6, a minimum modulation order of 2, a maximum spectral efficiency of 948/1024*6 and a minimum spectral efficiency of 120/1024*2;
an MCS_8 table supporting a maximum modulation order of 8, a minimum modulation order of 2, a maximum spectral efficiency of 948/1024*6 and a minimum spectral efficiency of 120/1024*2; and
an MCS_U table supporting a maximum modulation order of 6, a minimum modulation order of 2, a maximum spectral efficiency not greater than 772/1024*6 and a minimum spectral efficiency greater than or equal to 30/1024*2 and less than or equal to 50/1024*2.

3. The modulation and coding method according to claim 2, wherein the MCS table set at least comprises following three MCS tables:
an MCS_6 BPSK table supporting a maximum modulation order of 6, a minimum modulation order of 1 or 2, a maximum spectral efficiency of 948/1024*6 and a minimum spectral efficiency of 120/1024*2;
the MCS_8 table supporting the maximum modulation order of 8, the minimum modulation order of 2, the maximum spectral efficiency of 948/1024*6 and the minimum spectral efficiency of 120/1024*2; and
an MCS_U_BPSK table supporting a maximum modulation order of 6, a minimum modulation order of 1 or 2, a maximum spectral efficiency not greater than 772/1024*6 and a minimum spectral efficiency greater than or equal to 30/1024*2 and less than or equal to 50/1024*2.

4. The modulation and coding method according to claim 3, wherein the predefined rule at least relates to one of:
a link direction;
higher-layer configuration signaling;
a user device type or a user device capability;
a format of the downlink control signaling, wherein the downlink control signaling carries the modulation and coding scheme field;
a cyclic redundancy check (CRC) scrambling method corresponding to the downlink control signaling, wherein the downlink control signaling carries the modulation and coding scheme field;
a channel quality indicator table corresponding to a reported channel quality indicator;
a predefined subcarrier spacing set;
a predefined time domain resource mapping method;
a predefined frequency domain resource set;
a predefined antenna port set; and
a predefined set of numbers of transmission layers.

5. The modulation and coding method according to claim 4, wherein the predefined rule at least relates to:
the link direction;
the higher-layer configuration signaling;
the format of the downlink control signaling, wherein the downlink control signaling carries the modulation and coding scheme field; and
the CRC scrambling method corresponding to the downlink control signaling, wherein the downlink control signaling carries the modulation and coding scheme field.

6-32. (canceled)

33. The modulation and coding method according to claim 4, wherein in a case where the format of the downlink control signaling comprises at least DCI format 1_0 and the downlink control signaling carries the modulation and coding scheme field, selecting the MCS table to determine the modulation and coding scheme further comprises:
selecting the MCS_6 table to determine the modulation and coding scheme; or
selecting the MCS_6 table or the MCS_U table according to a predetermined condition to determine the modulation and coding scheme.

34. The modulation and coding method according to claim 4, wherein in a case where the format of the downlink control signaling at least comprises DCI format 0_0 and the downlink control signaling carries the modulation and coding scheme field, selecting the MCS table to determine the modulation and coding scheme at least comprises one of:
selecting the MCS_6 table to determine the modulation and coding scheme, or selecting the MCS_6 table or the MCS_U table according to a predetermined condition to determine the modulation and coding scheme;
in a case where transform precoding is disabled, selecting the MCS table to determine the modulation and coding scheme further comprises: selecting the MCS_6 table to determine the modulation and coding scheme, or selecting the MCS_6 table or the MCS_U table according to a predetermined condition to determine the modulation and coding scheme; and
in a case where the transform precoding is enabled, selecting the MCS table to determine the modulation and coding scheme further comprises: selecting the MCS_6 BPSK table to determine the modulation and coding scheme, or selecting the MCS_6 BPSK table or the MCS_U_BPSK table according to a predetermined condition to determine the modulation and coding scheme.

35. The modulation and coding method according to claim 33, wherein the predetermined condition at least relates to one of:
a UE capability;
a UE category; and
higher-layer configuration signaling.

36. The modulation and coding method according to claim 35, wherein the higher-layer configuration signaling at least comprises BLER-target indication signaling.

37-47. (canceled)

48. A modulation and coding apparatus, comprising:
an information acquisition module, which is configured to select a modulation and coding scheme (MCS) table from an MCS table set according to a predefined rule; and
a first processing module, which is configured to determine a modulation order and a target code rate according to the selected MCS table and a modulation and coding scheme field read from downlink control signaling;
wherein the MCS table set comprises an MCS table supporting a minimum spectral efficiency less than 120/1024*2.

49. The modulation and coding apparatus according to claim 48, wherein the MCS table set at least comprises following three MCS tables:
an MCS_6 table supporting a maximum modulation order of 6, a minimum modulation order of 2, a maximum spectral efficiency of 948/1024*6 and a minimum spectral efficiency of 120/1024*2;
an MCS_8 table supporting a maximum modulation order of 8, a minimum modulation order of 2, a maximum spectral efficiency of 948/1024*8 and a minimum spectral efficiency of 120/1024*2; and
an MCS_U table supporting a maximum modulation order of 6, a minimum modulation order of 2, a maximum spectral efficiency not greater than 772/1024*6 and a minimum spectral efficiency greater than or equal to 30/1024*2 and less than or equal to 50/1024*2.

50. The modulation and coding apparatus according to claim 48, wherein the MCS table set at least comprises following three MCS tables:
an MCS_6 BPSK table supporting a maximum modulation order of 6, a minimum modulation order of 1 or 2, a maximum spectral efficiency of 948/1024*6 and a minimum spectral efficiency of 120/1024*2;
the MCS_8 table supporting the maximum modulation order of 8, the minimum modulation order of 2, the maximum spectral efficiency of 948/1024*6 and the minimum spectral efficiency of 120/1024*2; and
an MCS_U_BPSK table supporting a maximum modulation order of 6, a minimum modulation order of 1 or 2, a maximum spectral efficiency not greater than 772/1024*6 and a minimum spectral efficiency greater than or equal to 30/1024*2 and less than or equal to 50/1024*2.

51. The modulation and coding apparatus according to claim 48, wherein the predefined rule at least relates to one of:
a link direction;
higher-layer configuration signaling;
a user device category or a user device capability;
a format of the downlink control signaling, wherein the downlink control signaling carries the modulation and coding scheme field;
a cyclic redundancy check (CRC) scrambling method corresponding to the downlink control signaling, wherein the downlink control signaling carries the modulation and coding scheme field;
a channel quality indicator table corresponding to a reported channel quality indicator;
a predefined subcarrier spacing set;
a predefined time domain resource mapping method;
a predefined frequency domain resource set;
a predefined antenna port set; and
a predefined set of numbers of transmission layers.

52-54. (canceled)

55. A base station, comprising a first processor, a first memory and a first communications bus; wherein the first communications bus is configured to implement communication connection between the first processor and the first memory; and
the processor is configured to execute one or more first programs stored in the first memory, so as to implement steps of the modulation and coding method according to claim 1.

56. A terminal, comprising a second processor, a second memory and a second communications bus; wherein
the second communications bus is configured to implement communication connection between the second processor and the second memory; and
the second processor is configured to execute one or more second programs stored in the second memory, so as to implement steps of the modulation and coding method according to claim 1.

57. A computer-readable storage medium, wherein the computer-readable storage medium stores one or more first programs executable by one or more processors, so as to implement steps of the modulation and coding method according to claim 1.

58. The modulation and coding method according to claim 34, wherein the predetermined condition at least relates to one of:
a UE capability;
a UE category; and
higher-layer configuration signaling.

59. The modulation and coding method according to claim 58, wherein the higher-layer configuration signaling at least comprises BLER-target indication signaling.

60. The modulation and coding apparatus according to claim 49, wherein the MCS table set at least comprises following three MCS tables:
an MCS_6 BPSK table supporting a maximum modulation order of 6, a minimum modulation order of 1 or 2, a maximum spectral efficiency of 948/1024*6 and a minimum spectral efficiency of 120/1024*2;
the MCS_8 table supporting the maximum modulation order of 8, the minimum modulation order of 2, the maximum spectral efficiency of 948/1024*6 and the minimum spectral efficiency of 120/1024*2; and
an MCS_U_BPSK table supporting a maximum modulation order of 6, a minimum modulation order of 1 or 2, a maximum spectral efficiency not greater than 772/1024*6 and a minimum spectral efficiency greater than or equal to 30/1024*2 and less than or equal to 50/1024*2.

61. The modulation and coding apparatus according to claim 49, wherein the predefined rule at least relates to one of:
a link direction;
higher-layer configuration signaling;
a user device category or a user device capability;
a format of the downlink control signaling, wherein the downlink control signaling carries the modulation and coding scheme field;
a cyclic redundancy check (CRC) scrambling method corresponding to the downlink control signaling, wherein the downlink control signaling carries the modulation and coding scheme field;
a channel quality indicator table corresponding to a reported channel quality indicator;
a predefined subcarrier spacing set;
a predefined time domain resource mapping method;
a predefined frequency domain resource set;
a predefined antenna port set; and
a predefined set of numbers of transmission layers.
